(19) United States
(12) Patent Application Publication
(10) Pub. No.: US 2016/0062020 A1
(43) Pub. Date: Mar. 3, 2016

(54) RETARDATION FILM, AND CIRCULARLY POLARIZING PLATE AND IMAGE DISPLAY DEVICE USING THE RETARDATION FILM

(71) Applicant: KONICA MINOLTA, INC., Tokyo (JP)

(72) Inventors: Midori KOGURE, Kobe-shi, Hyogo (JP); Yukihito NAKAZAWA, Hino-shi, Tokyo (JP); Norie TANIHARA, Kobe-shi, Hyogo (JP); Kenji MISHIMA, Chuo-ku, Tokyo (JP); Rieko REN, Kobe-shi, Hyogo (JP); Kouji TASHIRO, Hachioji-shi, Tokyo (JP)

(73) Assignee: KONICA MINOLTA, INC., Chiyoda-ku, Tokyo (JP)

(21) Appl. No.: 14/784,234

(22) PCT Filed: May 14, 2014
(86) PCT No.: PCT/JP2014/062896

§ 371 Date: Oct. 13, 2015

(30) Foreign Application Priority Data
May 21, 2013 (JP) 2013-106829

(51) Int. Cl. G02B 5/30; G02F 1/13363

(52) U.S. Cl. CPC G02B 5/3083; G02F 1/13363; G02F 2001/133637

(57) ABSTRACT

A retardation film includes a cellulose ether derivative and a compound having a negative intrinsic birefringence, wherein the retardation film includes: a transmittance at a wavelength of 320 to 400 nm of 89% or more; an in-plane retardation Ro₅₅₀ at a wavelength of 550 nm of 115 to 160 nm; and a ratio (Ro₄₅₀/Ro₅₅₀) of an in-plane retardation Ro₄₅₀ at a wavelength of 450 nm to the Ro₅₅₀ of 0.72 to 0.94.

### TECHNICAL FIELD

The present invention relates a retardation film, and a circularly polarizing plate and an image display device using the retardation film.

### BACKGROUND ART

Recently, there are various displays, such as a smartphone, a tablet display and an organic EL display. Along with diversification in usage or application of such displays, requirements for a protective film and a retardation film are also becoming diversified.

Further, although conventional liquid crystal displays have been used for viewing images, mainly, in doors, a smartphone or a tablet display is frequently used not only indoors but also outdoors. Therefore, a retardation film for used in these devices requires that it is free from the occurrence of degradation, bleed-out, and change in optical property values even after being exposed to a harsher environment than before. Particularly, an organic EL display requires that it is capable of coping with not only application for viewing in doors and/or out of doors but also a flexible display. Therefore, a retardation film for use in such an organic EL display requires more excellent durability and handleability than before.

Meanwhile, a bonding step in a process of forming a polarizing plate using a retardation film is also becoming diversified. Specifically, there are a technique of bonding a cellulose acetate resin-based film which has heretofore been used as a protective film for a polarizing plate, and a PVA polarizer by liquid glue, and a technique of bonding the film and the polarizer by using an active energy ray-curable adhesive (e.g., ultraviolet-curable adhesive; hereinafter also referred to as “UV adhesive”) and under irradiation with ultraviolet rays (UV light).

As a retardation film capable of meeting such diversifying requirements, great interest has been shown in a λ/4 retardation film. One property required for a λ/4 retardation film is that, in a wide wavelength region over the visible light region, a retardation of the film becomes one-quarter of each wavelength (λ), i.e., a reverse wavelength dispersion characteristic. Such a λ/4 retardation film is formed into a polarizing plate, to make it possible to prevent outside-light reflection in an organic EL display to enhance contrast under bright conditions and black color reproducibility.

As a conventional λ/4 retardation film, for example, there have been known a type using a cellulose acetate resin, and a type using a cyclic olefin resin having low water permeability. As a λ/4 retardation film using a cellulose acetate resin, a film containing a low-molecular-weight additive has been known (see, for example, the following Patent Literature 1). There have also been known a λ/4 retardation film using an ethoxy group-substituted cellulose derivative (see, for example, the following Patent Literature 2), and an optical film using an ether group-substituted cellulose derivative (see, for example, the following Patent Literature 3).

The additive to be added to the film described in the Patent Literature 1 exhibits absorption in a wavelength region greater than 320 nm. Thus, this film undesirably absorbs UV light, and therefore a UV adhesive cannot be used during formation of a polarizing plate. Moreover, the film using a cellulose acetate resin is excellent in water-permeability, so that an obtainable polarizing plate is not sufficient in terms of durability under a high-humidity condition, and thereby optical property values and the like are liable to change. On the other hand, the film using a cyclic olefin resin is insufficient in terms of the reverse wavelength dispersion characteristic. For compensating for this disadvantage, it is conceivable to employ a technique of laminating two retardation films while setting respective optical axis directions thereof in a misaligned manner. However, the resulting 714 retardation film is undesirably increased in film thickness, and involves a problem with viewability from an oblique direction when incorporated in an organic EL display. The films described in the Patent Literatures 2 and 3 are also insufficient for use as a light reflection preventive film for an organic EL display, in terms of wavelength dispersion characteristic.

### CITATION LIST

### Patent Literature

Patent Literature 1: JP 2007-249180A
Patent Literature 2: JP 2003-329835A
Patent Literature 3: JP 2003-96207A

### SUMMARY OF INVENTION

The present invention has been made in view of the above conventional problems, and an object thereof is to provide a retardation film capable of exhibiting an excellent reverse wavelength dispersion characteristic while reducing a change in optical property values in a high-humidity environment, and bondable to a polarizer by using an active energy rat-curable adhesive, and an circularly polarizing plate using the retardation film, and to provide an image display device having excellent black color reproducibility even under outside light, using the retardation film or the circularly polarizing plate.

According to one aspect of the present invention, there is provided a retardation film which comprises a cellulose ether derivative and a compound having a negative intrinsic birefringence. The retardation film has: a transmittance at a wavelength of 320 to 400 nm of 89% or more; an in-plane retardation Ro₅₅₀ at a wavelength of 550 nm of 115 to 160 nm; and a ratio (Ro₄₅₀/Ro₅₅₀) of an in-plane retardation Ro₄₅₀ at a wavelength of 450 nm to the Ro₅₅₀ of 0.72 to 0.94.

These and other objects, features, and advantages of the present invention will become apparent from the detailed description and the accompanying drawings.

### BRIEF DESCRIPTION OF DRAWINGS

FIG. 1 is a schematic diagram illustrating a contraction ratio in oblique stretching.

FIG. 2 is a schematic diagram illustrating one example of a rail pattern of an oblique stretching unit applicable to production of a retardation film according to one embodiment of the present invention.

FIGS. 3A to 3C are schematic diagrams illustrating a process of producing a retardation film according to one embodiment of the present invention (an example where a long film is fed from a roll thereof and then subjected to oblique stretching).

FIGS. 4A and 4B are schematic diagrams illustrating a process of producing a retardation film according to one embodiment of the present invention (an example where a long film is continuously subjected to oblique stretching without winding a film into a roll).

FIG. 5 is a schematic diagram illustrating one example of a configuration of an organic EL display according to one embodiment of the present invention.

### DESCRIPTION OF EMBODIMENTS

An embodiment of the present invention will now be described in detail. However, the present invention is not limited thereto.

<Retardation Film>

A retardation film according to this embodiment comprises a cellulose ether derivative, and a compound having a negative intrinsic birefringence (negative intrinsic birefringent compound) (The retardation film will hereinafter be also referred to as “cellulose ether film”). As used in this specification, the term “retardation film” means an optical film having a specific optical function of imparting a retardation to light transmitted therethrough, wherein a film having a function of imparting an in-plane retardation of substantially a quarter-wavelength to a wavelength of given light to convert linearly-polarized light to circularly-polarized light or convert circularly-polarized light to linearly-polarized light will be particularly referred to as “λ/4 retardation film”.

From a viewpoint of converting linearly-polarized light to almost-perfect circularly-polarized light in a wide range of the visible light wavelength region, the λ/4 retardation film is preferably a wide-band type having a retardation of approximately a quarter-wavelength in the visible light wavelength region. As used in this specification, the term “retardation of approximately a quarter-wavelength in the visible light wavelength range” means having a reverse wavelength dispersion characteristic in which a retardation value becomes larger as the wavelength becomes longer, in a wavelength region of 400 to 700 nm.

Ro and Rth in the retardation film according to this embodiment are defined, respectively, by the following Formulas.

Ro=(nx−ny)×d(nm) Formula 1

Rth={(nx+ny)/2−nz}×d(nm) Formula 2

(In Formulas 1 and 2, nx, ny and nz denote: a refractive index in a slow axis direction x along which the refractive index has a maximum value in an in-plane direction of the retardation film; and a refractive index in a direction y perpendicular to the slow axis direction x in the in-plane direction of the retardation film; and a refractive index in a thickness direction z of the retardation film, respectively, and d (nm) denotes a thickness of the retardation film.)

Ro and Rth can be measured by using an automatic birefringence meter. Examples of the automatic birefringence meter include Axoscan produced by Axometrics Inc., and KOBRA-21ADH produced by Oji Scientific Instruments Co., Ltd. Specifically, they can be measured in the following manner.

1) The retardation film is subjected to humidity conditioning at 23° C. and 55% RH. An average of respective refractive indexes of the humidity-conditioned retardation film at 450 nm, 550 nm and 650 nm is measured using an Abbe's refractometer and a spectroscopic light source. Further, a thickness of the optical film is measured using a film thickness meter.

2) Each of three beams having respective measurement wavelengths 450 nm, 550 nm and 650 nm is entered to the humidity-conditioned retardation film in a direction parallel to a normal line to a surface of the film. In this state, in-plane retardations Ro₄₅₀, Ro₅₅₀ and Ro₆₅₀ are measured using Axoscan produced by Axometrics Inc. Concurrently, an in-plane slow axis of the retardation film can be ascertained using Axoscan produced by Axometrics Inc.

3) Each of the beams having respective measurement wavelengths 450 nm, 550 nm and 650 nm is entered to the retardation film at an angle φ (incident angle (φ)) with respect to the normal line to the surface of the film. In this state, respective retardations R (φ) based on the in-plane slow axis of the retardation film as an oblique axis (rotation axis) are measured using AxOscan produced by Axometrics Inc. When the angle φ is in the range of 0 to 50°, the measurement of the retardation R (φ) can be performed every 10° within the range, i.e., at 6 points.

4) From Ro and R (φ) measured at respective wavelengths (λ), and the average refractive index and the thickness, nx, fly and nz are calculated using Axoscan produced by Axometrics Inc. Then, retardations Rth₄₅₀, Rth₅₅₀ and Rth₆₅₀ in the thickness direction at the respective measurement wavelengths 450 nm, 550 nm and 650 nm are calculated based on the above Formula. Then, from the obtained Ro₄₅₀ and Ro₅₅₀, Ro₄₅₀/Ro₅₅₀ can be calculated. Further, from the obtained Ro₅₅₀ and Ro₆₅₀, Ro₅₅₀/Ro₆₅₀ can be calculated.

On an assumption that the in-plane retardation of the λ/4 retardation film at a wavelength of 450 nm is Ro₄₅₀, and the in-plane retardation of the λ/4 retardation film at a wavelength of 550 nm is Ro₅₅₀, the retardation film according to this embodiment is characterized in that Ro₅₅₀ is 115 to 160 nm, and a ratio (Ro₄₅₀/Ro₅₅₀) of Ro₄₅₀ to Ro₅₅₀ is 0.72 to 0.94.

Ro₅₅₀ may be 115 to 160 nm, preferably, 125 to 155 nm. If Ro₅₅₀ is beyond the range of 115 to 160 nm, the retardation at a wavelength of 550 nm does not become approximately a quarter-wavelength, and, when a circularly polarizing plate is produced using such a film, and applied, for example, to an organic EL display, reflected glare of indoor lighting is likely to significantly occur, thereby making it impossible to achieve color expression of black under bright conditions.

The ratio (Ro₄₅₀/Ro₅₅₀) of Ro₄₅₀ to Ro₅₅₀ may be 0.72 to 0.94, preferably, 0.84 to 0.92. If Ro₄₅₀/Ro₅₅₀ is beyond the range of 0.72 to 0.94 (i.e., if Ro₄₅₀/Ro₅₅₀ is less than 0.72, or if Ro₄₅₀/Ro₅₅₀ is greater than 0.94), the retardation does not exhibit an adequate reverse wavelength dispersion characteristic, thereby tending to cause hue variation when a circularly polarizing plate is produced using such a film, and hue change in humidity environments.

Generally, it is possible to increase the in-plane retardation (e.g., Ro₅₅₀) by increasing the thickness d of the retardation film. However, an increase in film thickness of the retardation film involves problems of an increase in thickness of an image display device such as an organic EL display, and deterioration in transmittance, resulting in deteriorated light extraction efficiency. Differently, in this embodiment, as a result of containing the cellulose ether derivative and the negative intrinsic birefringent compound, a retardation film having excellent retardation developability is produced even when the film thickness is reduced as described later.

The retardation film according to this embodiment has a transmittance at a wavelength of 320 to 400 nm of 89% or more. The term “transmittance at a wavelength of 320 to 400 nm” means a transmittance as measured when electromagnetic rays having a wavelength of 320 to 400 nm are emitted to the retardation film Preferably, the transmittance is 90% or more. Although an upper limit of the transmittance is not particularly limited, it is realistically set to about 95%. That is, the transmittance at a wavelength of 320 to 400 nm is 89% or more, preferably, 90 to 95%. The retardation film according to this embodiment has excellent transmittance in the above wavelength range corresponding to ultraviolet wavelengths, so that, in a process of laminating the retardation film to an aftermentioned polarizer to produce a circularly polarizing plate, an active energy ray-curable adhesive (UV adhesive) may be used. Specifically, in a state in which the UV adhesive is interposed between the retardation film and the polarizer, UV light is emitted from the side of the retardation film. The retardation film excellently transmits UV light, so that the UV light reaches the UV adhesive interposed between the retardation film and the polarizer and causes curing of the UV adhesive. As a result, the retardation film is bonded to the polarizer. For achieving excellent transparency represented by transmittance, it is effective to reduce diffusion and absorption of light inside the film by avoiding introduction of an additive or copolymer component capable of absorbing visible light or by removing a foreign substance in a polymer through highly-accurate filtration. It is also effective to reduce scattering and reflection of light on a film surface by reducing a surface roughness of a film contact portion during film formation (a cooling roller, a calendar roller, a drum, a belt, a coatable base material for film formation during solution casting, a conveyance roller, etc.) to reduce a surface roughness of the film surface.

In the above retardation film, an angle defined between the in-plane slow axis and a longitudinal direction thereof, i.e., an in-plane orientation angle, is preferably 15 to 85°, more preferably, 30 to 60°, further more preferably, 35 to 55°, most preferably, 40 to 50°. As long as the in-plane orientation angle falls within the range, a circularly polarizing plate can be easily produced by unrolling the retardation film having a slow axis in an oblique direction with respect to the longitudinal direction thereof, and a polarizer film having a transmission axis parallel to an longitudinal axis thereof, respectively, from rolls of them, and laminating the retardation film and the polarizer film to allow their longitudinal directions to be aligned with each other, in a roll-to-roll manner. This can lead to reduction in cutting loss which is advantageous in terms of production.

Next, components of the retardation film according to this embodiment will be described.

The retardation film comprises a resin component (cellulose ether derivative) as a primary component, and an additive component (including a component other than the resin component, such as a compound having a negative intrinsic birefringence).

(Cellulose Ether Derivative)

The retardation film contains, as a primary component, a cellulose ether derivative. The cellulose ether derivative has a positive intrinsic birefringence. As used in this specification, the term “primary component” means a component contained in a resin component constituting the retardation film, in an amount of 55 mass % or more. Further, as used in this specification, the term “resin having a positive intrinsic birefringence” generally means a resin having a property that a refractive index increases in a molecular orientation direction, and, particularly in this embodiment, means a resin having a property capable of developing a retardation in such a manner as to allow a refractive index to increase in the same direction as a stretching direction during stretching.

Preferably, the cellulose ether derivative used in this embodiment is a type derived by substituting a hydroxyl group of a cellulose with an alkoxy group having a carbon number of 4 or less. Specifically, a hydroxyl group of a cellulose is substituted with an alkoxy group consisting of one or more of a methoxy group, an ethoxy group, a propoxy group and a butoxy group. Particularly, it is preferable to use a type derived by substituting a hydroxyl group of a cellulose with an alkoxy group consisting of one or more of a methoxy group and an ethoxy group. Among them, it is possible to suitably use an ethylcellulose having an ethoxy substitution degree (DSet), preferably, of 1.8 to 2.8, more preferably, of 1.8 to 2.5.

As used in this specification, the term “DSet” indicates how much three hydroxyl groups existing at the 2-, 3- and 6-positions in a cellulose molecule are ethoxylated. For example, when the substitution degree is 3, it indicates that all of the three hydroxyl groups are ethoxylated. The substitution degree may be even at each of the positions, or may unevenly increase or decrease at one of the positions. The ether substitution degree can be quantitatively determined according to a method prescribed in ASTM D4794-96.

If the substitution degree is less than 1.8, a solvent capable of dissolving it by itself is limited to a specific type. Moreover, an obtainable film tends to have an increased water absorption rate, resulting in deteriorated dimensional stability. On the other hand, if the substitution degree is greater than 2.8, a solvent capable of dissolving it by itself is also limited to a specific type, and a cost of the resin itself tends to become high.

The cellulose ether derivative itself may be prepared by a heretofore-known method. For example, it may be produced by treating a cellulose with a strong caustic soda solution to prepare an alkali cellulose, and etherifing the alkali cellulose through a reaction with methyl chloride or ethyl chloride.

The cellulose ether derivative has a weight-average molecular weight, preferably, of 100,000 to 400,000, more preferably, of 130,000 to 300,000, further more preferably, 150,000 to 250,000. If the molecular weight is greater than 400,000, solubility of the cellulose ether derivative with respect to a solvent deteriorates. Moreover, an obtainable solution has an excessively high viscosity unsuitable for a solution casting process, tending to cause problems, such as difficulty in thermoforming, and deterioration in transparency of the film. On the other hand, if the molecular weight is less than 100,000, an obtainable film tends to have reduced mechanical strength.

As the cellulose ether derivative, a cellulose ether derivative produced from a single raw material, may be used, or a combination of two or more of a plurality of types of cellulose ether derivatives produced from different raw materials may be used.

(Negative Intrinsic Birefringent Compound)

The retardation film according to this embodiment is characterized in that it contains a compound having a negative intrinsic birefringence (negative intrinsic birefringent compound). By adding the negative intrinsic birefringent compound, it is possible to further impart the reverse wavelength dispersion characteristic to an obtainable film while adequately adjusting a retardation of the film. As used in this specification, the term “compound having a negative intrinsic birefringence (negative intrinsic birefringent compound)” means a compound having a property capable of exhibiting an optically negative uniaxial property when molecules thereof are uniaxially oriented. Thus, for example, in the case where the resin contains the negative intrinsic birefringent compound, when light enters into a layer formed such that molecules are uniaxially oriented, an optical refractive index in a direction of the orientation is less than an optical refractive index in a direction perpendicular to the orientation direction.

The negative intrinsic birefringent compound is not particularly limited, but any heretofore-known compound exhibiting a negative intrinsic birefringence may be used. As such a compound, for example, it is possible to use compounds described in paragraphs [0036] to [0092] of JP 2010-46834A.

Specifically, as the negative intrinsic birefringent compound, it is possible to use a polymer having a negative intrinsic birefringence.

Examples of the polymer having a negative intrinsic birefringence include: a polymer having a specific ring structure (disk-shaped ring such as aromatic ring or complex aromatic ring) in a side chain (e.g.: styrene-based polymer such as polystyrene, poly(4-hydroxy) styrene, or styrene maleic anhydride copolymer; polyvinylpyridine; or 9,9-bis(phenyl)fluorene-contained copolymer); (meth)acrylic-based polymer such as polymethylmethacrylate; cellulosic ester (except for any type having a positive birefringence); polyester (except for any type having a positive birefringence); acrylonitrile-based polymer; and alkoxysilyl-based polymer; and multi-component (binary, ternary, etc.) copolymers thereof. They may be used independently or in the form of a combination of two or more of them. Further, the above copolymer may be a block copolymer or may be a random copolymer.

In this embodiment, the polymer having a negative intrinsic birefringence is preferably an oligomer having a weight-average molecular weight of 800 to 20,000, more preferably, an oligomer having a weight-average molecular weight of 1500 to 15,000. As used in this specification, the term “oligomer” means a polymer in which a relatively small number (e.g., 200 or less) of monomers are bound together. As long as the weight-average molecular weight of the polymer having a negative intrinsic birefringence is 800 to 20,000, an obtainable retardation film has excellent durability. Further, as long as the weight-average molecular weight is 800 to 20,000, the polymer having a negative intrinsic birefringence has excellent compatibility with the cellulose ether derivative. This facilitates enhancement in the transmittance at a wavelength of 320 to 400 nm.

Such an oligomer is not particularly limited. Examples of the oligomer include: an oligomer comprising a styrene derivative structure; an oligomer comprising a maleimide derivative structure; an acrylonitrile-based oligomer; and a polymethylmethacrylate-based oligomer.

Preferably, the oligomer comprising a styrene derivative structure is an oligomer comprising a styrene derivative as a repeating unit. Such an oligomer is roughly classified into: an oligomer obtained by homopolymerizing styrene or a styrene derivative; an oligomer obtained by copolymerizing styrene or a styrene derivative, and another monomer; and a mixture of these oligomers. Examples of the oligomer obtained by homopolymerizing styrene or a styrene derivative may include: an oligomer obtained by homopolymerizing one of styrene, α-methylstyrene, o-methylstyrene, p-methylstyrene, p-chlorostyrene, o-nitrostyrene, p-aminostyrene, p-carboxylstyrene, p-phenyl styrene, and 2,5-dichlorostyrene.

Examples of the oligomer obtained by copolymerizing styrene or a styrene derivative, and another monomer, may include: a styrene-acrylonitrile copolymerized oligomer; a styrene-methacrylonitrile copolymerized oligomer; a styrene-methyl methacrylate copolymerized oligomer; a styrene-ethyl methacrylate copolymerized oligomer; a styrene-α-chloroacrylonitrile copolymerized oligomer; a styrene-methyl acrylate copolymerized oligomer; a styrene-ethyl acrylate copolymerized oligomer; a styrene-butyl acrylate copolymerized oligomer; a styrene-acrylic acid copolymerized oligomer; a styrene-methacrylic acid copolymerized oligomer; a styrene-butadiene copolymerized oligomer; a styrene-isoprene copolymerized oligomer; a styrene-maleic anhydride copolymerized oligomer; a styrene-itaconic acid copolymerized oligomer; a styrene-vinylcarbazole copolymerized oligomer; a styrene-N-phenylacrylamide copolymerized oligomer; a styrene-vinylpyridine copolymerized oligomer; a styrene-vinylnaphthalene copolymerized oligomer; an α-methylstyrene-acrylonitrile copolymerized oligomer; an α-methylstyrene-methacrylonitrile copolymerized oligomer; an α-methylstyrene-vinyl acetate copolymerized oligomer; a styrene-α-methylstyrene-acrylonitrile copolymerized oligomer; a styrene-α-methylstyrene-methyl methacrylate copolymerized oligomer; a styrene-styrene derivative copolymerized oligomer; a styrene-acryloylmorpholine copolymerized oligomer; and an α-methylstyrene-acryloylmorpholine copolymerized oligomer.

Preferably, the oligomer comprising a maleimide derivative structure is an oligomer comprising a maleimide derivative as a repeating unit. Such an oligomer may include: an oligomer obtained by homopolymerizing maleimide or a maleimide derivative; an oligomer obtained by homopolymerizing one of N-methylmaleimide, N-ethylmaleimide, N-phenylmaleimide, and N-methylthiomaleimide.

Examples of an oligomer obtained by copolymerizing a maleimide derivative and another monomer may include: an N-phenylmaleimide-acrylonitrile copolymerized oligomer; an N-phenylmaleimide-methacrylonitrile copolymerized oligomer; an N-phenylmaleimide-methyl methacrylate copolymerized oligomer; an N-phenylmaleimide-ethyl methacrylate copolymerized oligomer; an N-phenylmaleimide-α-chloroacrylonitrile copolymerized oligomer; an N-phenylmaleimide-copolymerized oligomer; an N-phenylmaleimide-copolymerized oligomer; an N-phenylmaleimide-copolymerized oligomer; an N-phenylmaleimide-copolymerized oligomer; an N-phenylmaleimide-methyl acrylate copolymerized oligomer; an N-phenylmaleimide-ethyl acrylate copolymerized oligomer; an N-phenylmaleimide-butyl acrylate copolymerized oligomer; an N-phenylmaleimide-acrylic acid copolymerized oligomer; an N-phenylmaleimide-methacrylic acid copolymerized oligomer; an N-phenylmaleimide-butadiene copolymerized oligomer; an N-phenylmaleimide-isoprene copolymerized oligomer; an N-phenylmaleimide-maleic anhydride copolymerized oligomer; an N-phenylmaleimide-itaconic acid copolymerized oligomer; an N-phenylmaleimide-vinylcarbazole copolymerized oligomer; an N-phenylmaleimide-N-phenylacrylamide copolymerized oligomer; an N-phenylmaleimide-vinylpyridine copolymerized oligomer; an N-phenylmaleimide-vinylnaphthalene copolymerized oligomer; an N-phenylmaleimide-acrylonitrile copolymerized oligomer; an N-phenylmaleimide-methacrylonitrile copolymerized oligomer; an N-phenylmaleimide-acryloylmorpholine copolymerized oligomer; an N-phenylmaleimide-vinyl acetate copolymerized oligomer; an N-phenylmaleimide-styrene-acrylonitrile copolymerized oligomer; and an N-phenylmaleimide-acryloylmorpholine copolymerized oligomer.

Among these oligomers, a styrene derivative-acryloylmorpholine copolymerized oligomer is preferable, particularly from a viewpoint of compatibility. They may be used independently or in the form of a combination of two or more of them.

The negative intrinsic birefringent compound is contained in the retardation film, preferably, in an amount of 5 to 25 mass %, more preferably, in an amount of 7 to 23 mass %, further more preferably, in an amount of 8 to 20 mass %. As long as the content of the negative intrinsic birefringent compound is set to 5 to 25 mass %, it becomes possible to facilitate realization of a retardation film having low internal haze and high transparency.

<Other Additives>

In addition to the aforementioned primary components, the retardation film according to this embodiment may further contain various other additives.

Examples of an additive addable into an aftermentioned dope include a plasticizer, a compatibilizer, a phosphorus-based flame retarder, a matting agent, an antioxidant, an antistatic agent, an anti-degradation agent, a peeling aid, a surfactant, a dye and fine particles. In this embodiment, one or more of the additives, except for the fine particles, may be added during preparation of a cellulose ether solution, or may be added during preparation of a particle dispersion liquid. As regards a polarizing plate for use in an image display device, it is preferable to add a plasticizer for imparting heat resistance and humidity resistance, an antioxidant, etc.

(Plasticizer)

In the retardation film according to this embodiment, various types of plasticizers may be used in combination in order to improve fluidity and flexibility of a composition. Examples of the plasticizers include a polyalcohol ester-based plasticizer, a glycolate-based plasticizer, a phthalic acid ester-based plasticizer, a citric acid ester-based plasticizer, a fatty acid ester-based plasticizer, a phosphoric acid ester-based plasticizer, a polycarboxylic acid ester-based plasticizer, and an acrylic-based plasticizer. According to the intended purpose, these plasticizers may be selectively used or used in combination, to cope with a wide range of application.

(Sugar Ester Compound)

The retardation film according to this embodiment may contain a sugar ester compound as a compatibilizer. The sugar ester compound may include a sugar ester compound, except for a cellulose ester, having at least one of a pyranose structural unit and a furanose structural unit in a number of 1 to 12, wherein all or a part of hydroxy groups thereof are esterified.

The sugar ester compound is not particularly limited. Examples of the compound (sugar) having the pyranose structural unit(s) and/or the furanose structural unit(s) include glucose, galactose, mannose, fructose, xylose, arabinose, lactose, sucrose, nystose, 1F-fructosylnystose, stachyose, maltitol, lactitol, lactulose, cellobiose, maltose, cellotriose, maltotriose, raffinose and kestose. The examples thereof further include genthiobiose, genthiotriose, genethiotetraose, xylotriose and galactosyisucrose. Among them, the compound having both of the pyranose structural unit(s) and the furanose structural unit(s) is particularly preferable. Specifically, for example, sucrose, kestose, nystose, 1F-fructosylnystose and stachyose are preferable, and sucrose is particularly preferable.

A monocarboxylic acid for use in esterifying all or a part of the hydroxy groups of the compound (sugar) having the pyranose structural unit(s) and/or the furanose structural unit(s) is not particularly limited, but heretofore-known monocarboxylic acids such as aliphatic monocarboxylic acid, alicyclic monocarboxylic acid and aromatic monocarboxylic acid, may be used independently, or in combination in the form of a mixture of two or more types thereof.

Examples of a preferred aliphatic monocarboxylic acid include: saturated fatty acids such as acetic acid, propionic acid, butyric acid, isobutyric acid, valeric acid, caproic acid, enanthic acid, caprylic acid, pelargonic acid, capric acid, 2-ethyl-hexanecarboxylic acid, undecylic acid, lauric acid, tridecyl acid, myristic acid, pentadecylic acid, palmitic acid, heptadecylic acid, stearic acid, nonadecanoic acid, arachic acid, behenic acid, lignoceric acid, cerotic acid, heptacosanoic acid, montanic acid, melissic acid and lacceric acid; and unsaturated fatty acids such as undecylenic acid, oleic acid, sorbic acid, linolic acid, linolenic acid, arachidonic acid and octenoic acid.

Examples of a preferred alicyclic monocarboxylic acid include acetic acid, cyclopentanecarboxylic acid, cyclohexanecarboxylic acid, cyclooctanecarboxylic acid and derivatives thereof.

Examples of a preferred aromatic monocarboxylic acid include: benzoic acid; aromatic monocarboxylic acid in which an alkyl group or an alkoxy group is introduced into a benzene ring of benzoic acid such as toluic acid; and aromatic monocarboxylic acid having two or more benzene rings, such as cinnamic acid, benzilic acid, biphenylcarboxylic acid, naphthalenecarboxylic acid and tetralincarboxylic acid, and derivatives thereof, and more specifically include xylic acid, hemellitic acid, mesitylene acid, prehnitic acid, γ-isodurylic acid, durylic acid, mesitoic acid, α-isodurylic acid, cuminic acid, α-toluic acid, hydratropic acid, atropic acid, hydrocinnamic acid, salicylic acid, o-anisic acid, m-anisic acid, p-anisic acid, creosotic acid, o-homosalicylic acid, m-homosalicylic acid, p-homosalicylic acid, o-pyrocatechuic acid, β-resorcylic acid, vanillic acid, isovanillic acid, veratric acid, o-veratric acid, gallic acid, asaronic acid, mandelic acid, homoanisic acid, homovanillic acid, homoveratric acid, o-homoveratric acid, phthalonic acid and p-coumaric acid. Among them, benzoic acid is particularly preferable.

In the retardation film according to this embodiment, from a viewpoint of suppressing fluctuation in retardation value to stabilize a quality level of display, the above sugar ester compound is preferably contained in an amount of 1 to 30 mass %, more preferably, 5 to 30 mass %, with respect to 100 mass % of the retardation film. As long as the content of the sugar ester compound is in the range of 1 to 30 mass %, it is possible to obtain the above excellent effects and suppress bleed-out or the like.

(Phosphorus-Based Flame Retarder)

The retardation film may be formed using a flame-retardant acrylic-based resin composition mixed with a phosphorus-based flame retarder. The phosphorus-based flame retarder may be one or a mixture of two or more selected from the group consisting of red phosphorus, triaryl phosphoric acid ester, diaryl phosphoric acid ester, monoaryl phosphoric acid ester, arylphosphonate compound, arylphosphine oxide compound, condensed aryl phosphoric acid ester, halogenated alkyl phosphoric acid ester, halogen-containing condensed phosphoric acid ester, halogen-containing condensed phosphonic acid ester, and halogen-containing phosphorous acid ester. More specifically, examples thereof include triphenylphosphate, 9,10-dihydro-9-oxa-10-phosphaphenanthrene-10-oxide, phenylphosphonate, tris(β-chloroethyl)phosphate, tris(dichloropropyl)phosphate, and tris(tribromoneopentyl)phosphate.

(Matting Agent (Fine Particles))

The retardation film according to this embodiment may contain fine particles. The fine particle is composed of an inorganic compound or an organic compound. Examples of the inorganic compound include silicon dioxide, titanium dioxide, aluminum oxide, zirconium oxide, calcium carbonate, calcium carbonate, talc, calcined kaolin, calcined calcium silicate, hydrated calcium silicate, aluminum silicate, magnesium silicate, and calcium phosphate. Examples of the organic compound include: polytetrafluoroethylene; cellulose acetate; polystyrene; polymethyl methacrylate; polypropyl methacrylate; polymethyl acrylate; polyethylene carbonate; acrylic styrene-based resin; silicone-based resin; polycarbonate resin; benzoguanamine-based resin; melamine-based resin; polyolefin-based powder; polyester-based resin; polyamide-based resin; polyimide-based resin; polyfluoroethylene-based resin; crushed and classified material of an organic polymer compound such as starch; polymer compound synthesized by a suspension polymerization method; and polymer compound formed into a spherical shape by a spray dry method, a dispersion method or the like.

The fine particle may be composed, preferably, of a compound containing silicon (preferably, silicon dioxide), from a viewpoint of its capability of maintaining a haze value of an obtainable film low. Examples of the fine particle of silicon dioxide include Aerosil R972, R972V, R974, R812, 200, 200V, 300, R202, OX50 and TT600 (produced by Nippon Aerosil Co., Ltd.).

Examples of the fine particle of zirconium oxide include Aerosil R976 and R811 (produced by Nippon Aerosil Co., Ltd.).

Examples of a material for the polymer fine-particle include silicone resin, fluororesin, and (meth)acrylic resin. Among them, a silicone resin is preferably, and a silicone resin having a three-dimensional network structure is more preferable. Examples of the silicone resin include Tospearl 103, 105, 108, 120, 145, 3120 and 240 (produced by Toshiba Silicones Co., Ltd.).

Among them, Aerosil 200V and Aerosil R972V are particularly preferably, from a viewpoint of their capability of enhancing slipperiness of a surface of the retardation film while maintaining a haze value of the film low.

Primary particles of the fine particles have an average particle size, preferably, of 5 to 400 nm, more preferably, of 10 to 300 nm. The fine particles may form secondary aggregates mainly having a particle size of 0.05 to 0.3 μm. As long as the average particle size of fine particles is 100 to 400 nm, the fine particles can exist as primary particles without aggregation.

In the retardation film according to the present invention, the fine particles are preferably contained to allow at least one of opposite surfaces thereof to have a dynamic friction coefficient of 0.2 to 1.0. The fine particles are contained in an amount, preferably, of 0.01 to 1 mass %, more preferably, of 0.05 to 0.5 mass %, with respect to 100 mass % of the thermoplastic resin.

The retardation film according to this embodiment may further contain a dispersant, from a viewpoint of enhancing dispersibility of the fine particles. Examples of the dispersant include an amine-based dispersant and a carboxyl group-containing polymer dispersant.

The amine-based dispersant is preferably alkylamine, or an amine salt of polycarboxylic acid, and specific examples thereof include a compound obtained by amnizing one of polyester acid, polyether ester acid, fatty acid, fatty acid amide, polycarboxylic acid, alkylene oxide, polyalkylene oxide, polyoxyethylene fatty acid ester, and polyoxyethylene glycerine fatty acid ester. Examples of the amine salt include amine-amide salt, aliphatic amine salt, aromatic amine salt, alkanolamine salt, and polyamine salt.

Specific examples of the amine-based dispersant include polyoxyethylene fatty acid amide, polyoxyethylene alkylamine, tripropylamine, diethylaminoethanamine, dimethylaminopropylamine, and diethylaminopropylamine. Examples of a related commercially-available product include Solsperse series (produced by Lubrizol Corporation), Ajisper series (produced by Ajinomoto Co., Inc.), BYK series (produced by BYK Japan KK), and EFKA series (produced by EFKA Chemical B.V.)

The carboxyl group-containing polymer dispersant is preferably a polycarboxylic acid or a salt thereof, and examples thereof include polycarboxylic acid, ammonium polycarboxylate, and sodium polycarboxylate. More specific examples thereof include polyacrylic acid, ammonium polyacrylate, sodium polyacrylate, ammonium polyacrylate copolymer, polymaleic acid, ammonium polymalate, and sodium polymalate.

The amine-based dispersant or the carboxyl group-containing polymer dispersant may be used by dissolving it in a solvent component, or a related commercially-available product may be used.

Depending on a type of the dispersant, the dispersant is preferably contained in an amount of 0.2 mass % or more, with respect to 100 mass % of the fine particles. If the content of the dispersant is less than 0.2 mass % with respect to 100 mass % of the fine particles, the dispersant is likely to fail to sufficiently ensure dispersibility of the fine particles.

In the case where the retardation film according to this embodiment further contains a surfactant or the like, adsorption of the dispersant to surfaces of the fine particles becomes less likely to occur, as compared to the surfactant, thereby easily causing re-aggregation of the fine particles. The dispersant is costly, and therefore it is preferable to minimize the content thereof. However, if the content of the dispersant is excessively small, wettability of the fine particles and stability of the dispersion are likely to deteriorate. Therefore, in the case where the retardation film according to this embodiment further contains a surfactant or the like, the content of the dispersant may be set to about 0.05 to 10 weight parts, with respect to 10 weight parts of the fine particles.

(Others)

Various antioxidants may be further added to the retardation film to improve thermal degradation resistance and thermal coloration resistance. Further, an antistatic agent may be added to impart antistatic ability to the retardation film.

(Organic Solvent)

In this embodiment, in order to dissolve the cellulose ether derivative therein to prepare a cellulose ether solution, i.e., dope, an organic solvent may be used. As the organic solvent, it is possible to mainly use a chlorine-based organic solvent and a non-chlorine-based organic solvent.

Examples of the chlorine-based organic solvent may include methylene chloride. Examples of the non-chlorine-based organic solvent include methyl acetate, ethyl acetate, amyl acetate, acetone, tetrahydrofuran, 1,3-dioxolane, 1,4-dioxane, cyclohexanone, ethyl formate, 2,2,2-trifluoroethanol, -hexafluoro-1-propanol, 1,3-difluoro-2-propanol, 1,1,1,3,3,3-hexafluoro-2-methyl-2-propanol, 1,1,1,3,3,3-hexafluoro-2-propanol, 2,2,3,3,3-pentafluoro-1-propanol, and nitroethane. From a viewpoint of recent environmental concerns, the non-chlorine-based organic solvent is preferably used.

In the case where one of the above organic solvents is used for the cellulose ether derivative, it is preferable to reduce an un-dissolved substance by using a heretofore-known dissolution process such as a dissolution process at normal temperature, a high-temperature dissolution process, a cooled dissolution process or a high-pressure dissolution process. While methylene chloride may be used for the cellulose ether derivative, it is preferable to use methyl acetate, ethyl acetate or acetone. Among them, methyl acetate is particularly preferable.

In this specification, an organic solvent having excellent solubility to the cellulose ether derivative will be referred to as “good solvent”, and an organic solvent capable of exhibiting a main effect on dissolution and used in a significant amount for the dissolution is called a main (organic) solvent or a primary (organic) solvent.

Preferably, a dope for use in film formation of the retardation film, according to this embodiment contains alcohol having a carbon number of 1 to 4, in an amount of 1 to 40 mass %, in addition to the organic solvent. The alcohol can act as a gelation-causing solvent for, when vaporization of the organic solvent starts after casting the dope on a metal support and thereby a relative ratio of the alcohol component increases, causing the dope film (web) to gelate, thereby making the web strong to facilitate peel-off of the web from the metal support, and also has a function of promoting dissolution of the cellulose ether derivative into the non-chlorine-based organic solvent, when a content ratio of the alcohol is small.

Examples of the alcohol having a carbon number of 1 to 4 include methanol, ethanol, n-propanol, iso-propanol, n-butanol, sec-butanol, and tert-butanol Among them, it is preferable to use ethanol, from the viewpoint of its excellent stability to a dope, a relatively low boiling point, good dryability, etc.

Preferably, a concentration of the cellulose ether derivative in the dope is in the range of 10 to 35 mass %, and a viscosity of the dope is adjusted to fall within the range of 100 to 500 Pa·s, from a viewpoint of obtaining excellent film surface quality.

<Physical Properties of Retardation Film>

In addition to the transmittance at a wavelength of 320 to 400 nm, the retardation film according to this embodiment has, for example, the following physical properties. It should be understood that the following physical properties will be shown by way of example, and the retardation film according to this embodiment is not limited to a film having the following physical properties.

(Film Thickness and Width)

A film thickness of the retardation film is not particularly limited, but may be set in the range of 10 to 250 μm. The retardation film according to this embodiment contains the cellulose ether derivative and the negative intrinsic birefringent compound, so that it becomes possible to enhance the retardation developability without increasing a film thickness as before. For example, the film thickness may be set to 20 to 100 μm, or may be set to a reduced value of 20 to 80 μm, or to a further reduced value of 20 to 50 μm. Even with such a film thickness, the retardation film can exhibit sufficiently good retardation developability and reverse wavelength dispersion characteristic.

A width of the retardation film is not particularly limited, but may be set in the range of 1 to 4 m, preferably, 1.4 to 4 m, more preferably, 1.6 to 3 m. As long as the width of the retardation film is 4 m or less, conveyance stability thereof can be ensured.

<Retardation Film Production Method>

Next, a production method for the aforementioned retardation film will be described.

The retardation film according to this embodiment can be formed according to a heretofore-known process. The following description will be made based on a solution casting process and a melt casting process, as representative examples.

(Solution Casting Process)

The retardation film according to this embodiment can be produced by a solution casting process. The solution casting process comprises: a step of heating and dissolving a thermoplastic resin, such as the cellulose ether derivative (hereinafter also referred to simply as “cellulose ether”), and additives (comprising the negative intrinsic birefringent compound), in an organic solvent to prepare a dope; a step of casting the prepared dope on a belt-shaped or drum-shaped metal support; a step of drying the cast dope to form a web; a step of peeling the web from the metal support; a step of stretching or contracting the peeled web; a step of additionally drying the stretched or contracted web; and a step of winding up a finished film.

(Dope Preparation Step)

In the dope preparation step, a concentration of the cellulose ether contained in the dope is preferably set to a higher value, because a drying load after casting onto the metal support can be more largely reduced. However, if the concentration of the cellulose ether is excessively high, a load during filtration is increased, resulting in poor filtration accuracy. Thus, in order to satisfy both of the needs, the concentration is set preferably in the range of 10 to 35 mass %, more preferably, in the range of 15 to 30 mass %.

A concentration of the negative intrinsic birefringent compound in the dope, is preferably, in the range of 0.5 to 10 mass %, more preferably, 0.6 to 9 mass %. As long as the concentration of the negative intrinsic birefringent compound falls within the above range, the negative intrinsic birefringent compound exhibits excellent compatibility with the cellulose ether derivative in the dope, so that a homogeneous dope can be obtained. Therefore, a retardation film formed using such a homogeneous dope becomes more capable of increasing the transmittance at a wavelength of 320 to 400 nm. In particular, in the case where a weight-average molecular weight of the negative intrinsic birefringent compound is 800 to 20,000, the comparability with the cellulose ether derivative becomes particularly excellent. Therefore, the homogeneity of the dope is enhanced, so that an obtainable retardation film becomes more capable of increasing the transmittance at a wavelength of 320 to 400 nm.

(Casting Step)

The metal support to be used in the casting step is preferably a type having a mirror-finished surface, and preferably composed of a stainless steel belt, or a drum formed of a cast metal having a plated surface.

A width of the casting is preferably set in the range of 1 to 4 m. A surface temperature of the metal support during the casting step is appropriately selectively set in the range of −50° C. or more to a temperature at which the solvent is not foamed due to boiling. The temperature is preferably set to a higher value, because a drying speed of the web can be more largely increased. However, if the temperature is excessively high, the web is likely to be foamed, resulting in deterioration in flatness thereof. A preferred temperature of the metal support is 0 to 100° C., more preferably, 5 to 30° C. Then, the web is cooled to cause gelation, so that the gelated web can be peeled off from the drum in a state in which it largely contains a residual solvent. A technique for controlling the temperature of the metal support is not particularly limited. For example, it is conceivable to employ a technique of blowing warm or cool air thereonto, or a technique of allowing warm water to come into contact with a back side of the metal support. The technique using warm water is more preferable, because heat transfer is efficiently performed to shorten a time period before the temperature of the metal support becomes constant. In the technique using warm air, considering a temperature decrease of the web due to latent heat of vaporization, warm air having a temperature equal to or greater than a boiling point of the solvent and greater than a target temperature is used while preventing the foaming, in some cases. In particular, it is preferable to efficiently perform the drying by changing the temperature of the support and the temperature of the drying air during a time period from start of the casting to completion of the peeling.

For allowing the λ/4 retardation film to exhibit good flatness, an amount of the residual solvent at a time when the web is peeled off from the metal support is set preferably in the range of 10 to 150 mass %, more preferably, in the range of 20 to 40 mass % or 60 to 130 mass %, further more preferably in the range of 20 to 30 mass % or of 70 to 120 mass %.

In this specification, the residual solvent amount is defined by the following formula.

Residual solvent amount(mass %)={(M−N)/N}×100
(where M represents a mass of a sample obtained by collecting the web or film at an arbitrary time during or after production thereof, and N represents a mass of the collected sample after it is subjected to heating at 115° C. for 1 hour.)

(Drying Step)

In the drying step, the web is peeled off from the metal support, and further dried to allow the residual solvent amount to be preferably 1.0 mass % or less, more preferably, 0.01 mass % or less.

In the drying step, it is generally able to employ a roll drying method, for example, a method configured to allow the web to alternately pass through a large number of rollers arranged up and down, and a method configured to dry the web while conveying it according to a tenter system.

(Stretching Step)

As mentioned above, in the retardation film according to this embodiment, the in-plane retardation Ro₅₅₀ measured at a wavelength 550 nm is preferably 115 to 160 um. Such a retardation can be imparted by stretching a film.

A technique for stretching is not particularly limited. For example, it is possible to employ; a technique of driving a plurality of rollers at respective different circumferential speeds, and performing a stretching operation in a machine direction by means of the difference in circumferential speed between the rollers; a technique of fixing opposite edges of a web by clips or pins, and performing a stretching operation in the machine direction by increasing a distance between the clips or pins in their traveling direction; a technique of performing a stretching operation in a transverse direction by increasing the above distance in the transverse direction; and a technique of performing a stretching operation in the machine and transverse directions by increasing the above distance in the machine and transverse directions, individually or in the form of a combination of two or more of them. That is, the stretching operation may be performed in the transverse direction with respect to a film formation direction (the machine or conveyance direction), or may be performed in the machine direction, or may be performed in the two directions. Further, when the stretching operation is performed in the two directions, it may be performed in a simultaneous manner, or may be performed in a sequential manner. In a so-called tenter system, a linear driving scheme is preferably used to drive a clip portion so as to achieve a smooth stretching operation and thus reduce a risk of breakage or the like.

Generally, in the stretching step, it is often the case that a stretching operation is performed in a width direction (TD direction) while causing a contraction in a conveyance direction (MD direction). In this case, during the contraction, a conveyance operation may be performed in an oblique direction. This makes it easier to uniform orientation of main chains, and thereby a retardation developing effect is further enhanced. A contraction ratio can be set by a conveyance angle.

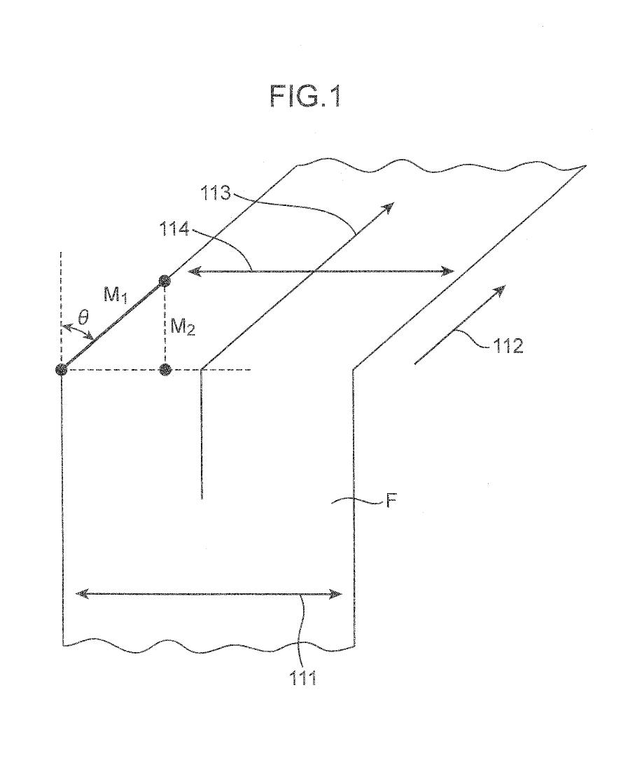

FIG. 1 is a schematic diagram for explaining a contraction ratio in an oblique stretching. In FIG. 1, when a cellulose acylate film F is obliquely stretched in a direction indicated by the reference sign 112, the cellulose acylate film F is obliquely bent and thus M₁ contracted to M₂.

In the above case, the contraction ratio (%) is expressed as follows:

Contraction ratio (%)=((M₁−M₂)/×100

In this formula, M₂=M₁×sin (π−θ), where θ is a bending angle.
Thus, the contraction ratio is expressed as follows:

Contraction ratio (%)=(1−sin(π−θ))×100

In FIG. 1, the reference sign 111, the reference sign 113 and the reference sign 114 denote, respectively, the stretching direction, the conveyance direction (MD direction) and the slow axis.

Considering productivity of a circularly polarizing plate, the λ/4 retardation film according to this embodiment is preferably configured such that the orientation angle with respect to the conveyance direction is set to 45°±2°, to allow for lamination with a polarizing film in a roll-to-roll manner.

(Stretching by Oblique Stretching Unit)

Next, an oblique stretching process of stretching in a 45-degree direction will be described in more detail. In a production method for the retardation film according to this embodiment, as a means to impart an oblique orientation to a stretched cellulose ether film, it is preferable to employ an oblique stretching unit.

Preferably, an oblique stretching unit applicable to this embodiment is a film stretching unit capable of: freely setting an orientation angle of a film by variously changing a rail pattern; highly accurately setting an orientation axis of the film laterally evenly over a width direction of the film; and highly accurately controlling a thickness and retardation of the film.

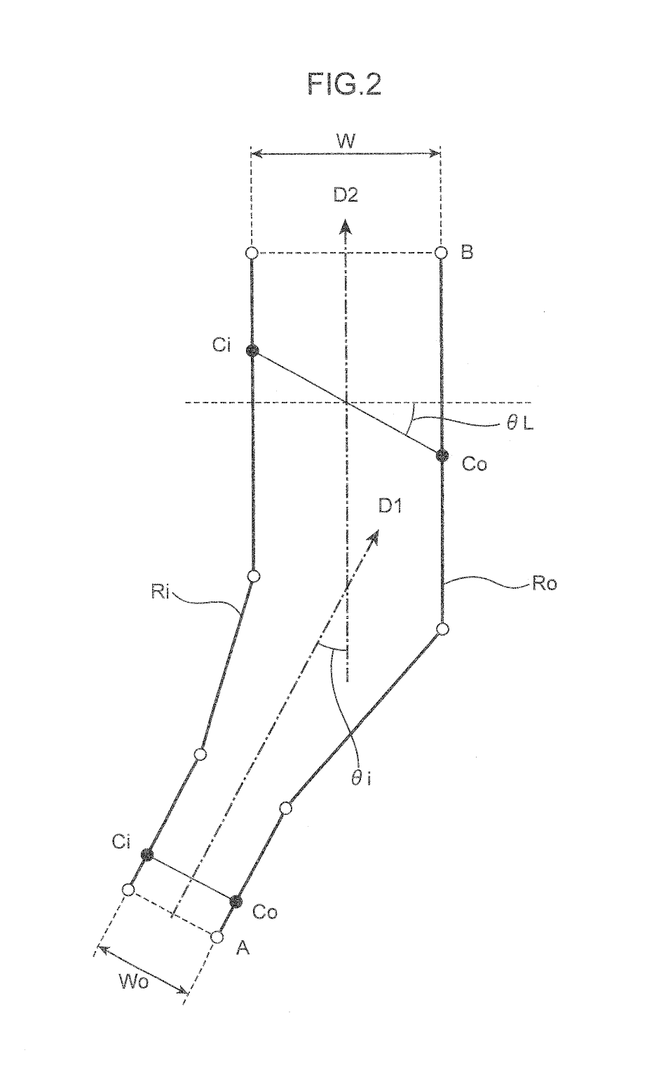

FIG. 2 is a schematic diagram illustrating an example of an oblique stretching unit applicable to production of the λ/4 retardation film according to this embodiment. The illustration depicted therein is presented only by way of example, and the stretching unit applicable to this embodiment is not limited thereto.

Generally, in the oblique stretching unit, as illustrated in FIG. 2, a feeding direction D1 of a long film from a roll thereof is different from a winding direction D2 of a stretched film after stretching, to define an extension angle θi therebetween. The extension angle θi can be arbitrarily set at a desired angle within the range of greater than 0° to less than 90°. As used in this specification, the term “long” means that a length of a film is at least about 5 times or more, preferably, 10 times or more, a width thereof.

Opposite lateral edges of the long film are held by right and left grippers (tenters) at an inlet of the oblique stretching it (at the position A in FIG. 2), and the long film travels along with traveling of the grippers. The left and right grippers Ci, Co located in opposed relation in a direction approximately perpendicular to a film traveling direction (feeding direction D1) travel, respectively, along bilaterally asymmetric rails Ri, Ro, and release a holding state of the stretched film at a position where stretching is terminated (at the position B in FIG. 2).

In this process, as the left and right grippers located in opposed relation at the inlet of the oblique stretching unit (at the position A in FIG. 2) travel, respectively, along the bilaterally asymmetric rails Ri, Ro, the gripper Ci traveling along the rail Ri and the gripper Co traveling along the rail Ro have a positional relationship in which the gripper Ci goes ahead of the gripper Co.

Specifically, in a state in which the grippers Ci, Co which have been located in opposed relation in a direction approximately perpendicular to the film feeding direction D1 at the inlet A of the oblique stretching unit (at a holding start position where the grippers start to hold the film) are located at the position B where stretching is terminated, a straight line connecting the grippers Ci, Co is inclined with respect to the direction approximately perpendicular to the film winding direction D2 by an angle θL.

According to the above process, the film is obliquely stretched to have an orientation angle of θL. As used herein, the term “approximately perpendicular” means an angle falling within 90±1°.

More specifically, it is preferable that the production method in this embodiment is configured to perform oblique stretching by using the oblique stretching unit capable of performing oblique stretching as mention above. This stretching unit is capable of heating a film to an arbitrary stretchable temperature and then performing an oblique stretching operation. In this case, the stretching unit may comprise a heating zone, a pair of right and left rails for allowing aftermentioned grippers for conveying a film to travel thereon, and a large number of grippers configured to travel on the rails. The grippers are configured to introduce a film sequentially supplied to an inlet of the stretching unit, into the heating zone, while sequentially holding opposite lateral edges of the film, and release the film at an outlet of the stretching unit. The film released from the grippers is wound around a roll core. Each of the pair of rails has an endless continuous track, and thereby the grippers releasing the held state of the film at the outlet of the stretching unit are sequentially returned to the inlet while traveling along an outer track.

The rail pattern of the stretching unit has a bilaterally asymmetrical shape, and can be adjusted manually or automatically, depending on an orientation angle θ to be imparted to a long stretched film to be produced, a stretching ratio, etc. Preferably, the oblique stretching unit used in the production method in this embodiment is capable of freely setting positions of rail elements and rail connecting portions so as to arbitrarily change the rail pattern (areas indicated by circular marks in FIG. 2 show one example of the rail connecting portions).

In this embodiment, each of the grippers of the stretching unit is configured to travel at a constant speed, while maintaining a constant distance with respect to each of the preceding and subsequent grippers. While the traveling speed of each of the grippers may be appropriately selected, it is typically set to 1 to 100 m/min. A difference between respective traveling speeds of the pair of right and left grippers is generally 1% or less, preferably, 0.5% or less, more preferably, 0.1% or less, of one's respective traveling speeds. The reason is because, if there is a difference in traveling speed between right and left edges of a film at the outlet of the stretching unit, wrinkles and shifting occur at the outlet of the stretching unit, and therefore it is necessary for the right and left grippers to have substantially the same speed, i.e., no speed difference therebetween. In a commonly-used stretching unit and the like, depending on a tooth pitch of a sprocket for driving a chain, a frequency of a drive motor and others, there occur speed fluctuations in sub-second order, often at a level of several %. These do not fall under a category of the speed difference set forth in this embodiment.

In the stretching unit used in this embodiment, particularly, the rail defining a track of each of the grippers is often required to have a large bending curvature. For avoiding interference between the grippers or local stress concentration due to sharp bending, it is preferable to allow the track of the gripper to form a curved line at the bent area.

In this embodiment, opposite lateral edges of the long film are held by the right and left grippers at the inlet of the oblique stretching unit (at the position A in FIG. 2), and the long film travels along with traveling of the grippers. The left and right grippers located in opposed relation in a direction approximately perpendicular to the film traveling direction (feeding direction D1) travel, respectively, along the bilaterally asymmetric rails, and pass through a heating zone comprising a preheating zone, a stretching zone and a heat setting zone.

The preheating zone means a zone in which the pair of grippers holding the opposite lateral edges of the film travel while maintaining a distance therebetween constant in an inlet region to the heating zone.

The stretching zone means a zone in which the distance between the pair of grippers holding the opposite lateral edges of the film starts increasing and then reaches a given distance. In the stretching zone, the aforementioned oblique stretching is performed. According to need, before and after the oblique stretching, an additional stretching may be performed in the machine direction or the transverse direction. The oblique stretching involves a contraction in the MD direction (fast axis direction), i.e., a direction perpendicular to a slow axis, during bending.

The λ/4 retardation film according to this embodiment is subjected to stretching, follows by contracting, so that the additive (e.g., negative intrinsic birefringent compound) away from a main chain of the cellulose ether a matrix resin can be rotated to allow a main axis of the additive to become coincident with the main chain of the cellulose ether. This makes it possible to steepen a slope of wavelength dispersion.

The heat setting zone means a zone in which the distance between the grippers after the stretching zone becomes constant again, wherein the grippers at the respective opposite lateral edges of the film travel while maintaining a mutual parallel relation. After passing through the heat setting zone, the film may pass through a zone (cooling zone) in which a temperature therein is set to be equal to or less than a glass transition temperature Tg of the thermoplastic resin constituting the film. In this case, the trail pattern may be preliminarily set such that the distance between the opposed grippers is narrowed, considering shrinkage of the film due to the cooling.

As regards respective temperatures of the above zones, based on a glass transition temperature Tg of the thermoplastic resin, the temperature of the preheating zone, the temperature of the stretching zone and the temperature of the cooling zone are set, respectively, to Tg to Tg+30° C., Tg to Tg+30° C., and Tg−30° C. to Tg.

In order to control thickness unevenness in the width direction, a temperature in the stretching zone may be set in such a manner as to vary in the width direction. As means to allow the temperature in the stretching zone to vary in the width direction, it is possible to employ a heretofore-known technique, such as a technique of allowing respective degrees of opening of a plurality of nozzles for sending hot air into a temperature-controlled chamber to vary in the width direction, or a technique of heat-controlling a plurality of heaters arranged along the width direction.

Respective length of the preheating zone, the stretching zone and the heat-setting zone may be appropriately selected. For example, with respect to the length of the stretching zone, the length of the preheating zone is generally in the range of 100 to 150%, and the length of the heat setting zone is generally in the range of 50 to 100%.

A stretching ratio (W/Wo) in the stretching step is preferably 1.3 to 3.0, more preferably, 1.5 to 2.8. As long as the stretching ratio falls within the above range, it is possible to reduce thickness unevenness in the width direction. In the stretching zone of the oblique stretching unit, a stretching temperature may be set in such a manner as to vary in the width direction. In this case, it becomes possible to further improve the thickness unevenness in the width direction. In the above description, Wo represents a width of the film before the stretching, and W represents a width of the film after the stretching.

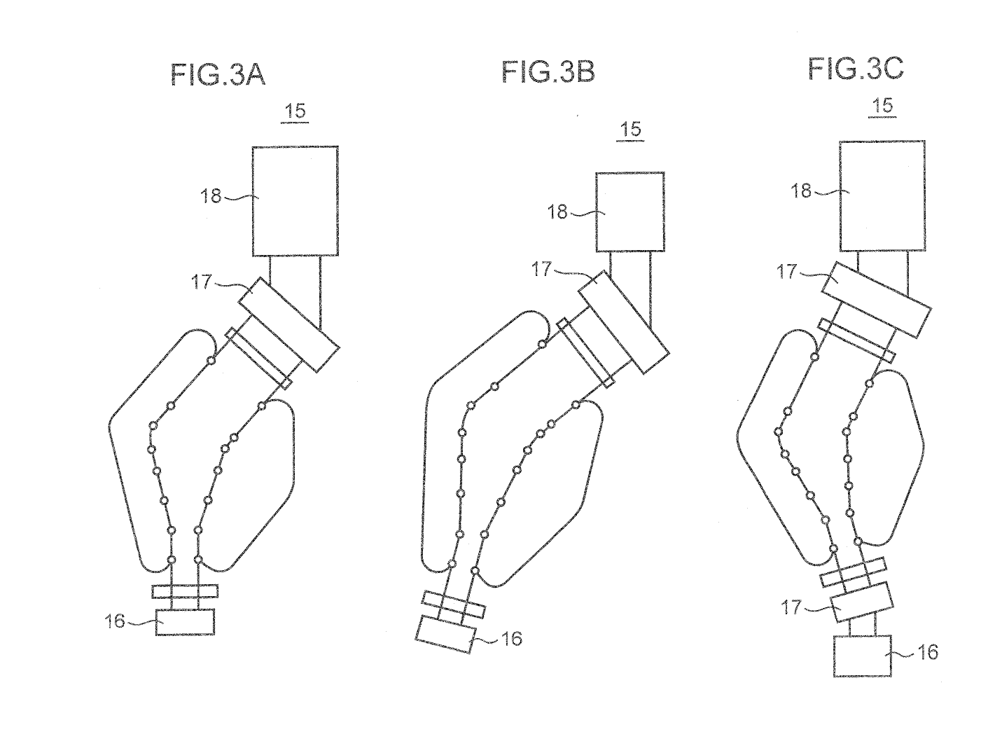

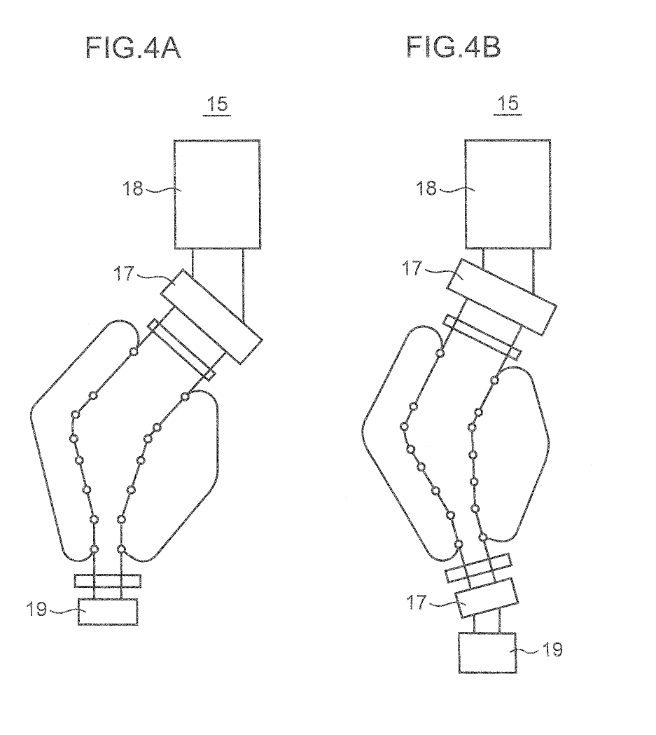

Examples of an oblique stretching technique applicable to this embodiment include stretching techniques illustrated in FIGS. 3A to 3C and FIGS. 4A and 4B, in addition to the technique illustrated in FIG. 2.

FIGS. 3A to 3C are schematic diagrams illustrating a process of producing the retardation film according to this embodiment (an example where a long film is fed from a roll thereof and then subjected to oblique stretching), wherein the process is configured to, after winding up a long film into a roll once, feed the film from the roll and subject the film to oblique stretching. FIGS. 4A and 4B are schematic diagrams illustrating another process of producing the retardation film according to this embodiment (an example where a long film is continuously subjected to oblique stretching without being wound up into a roll), wherein the process is configured to continuously subject the film to oblique stretching without winding up it into a roll.

In FIGS. 3A to 3C and FIGS. 4A and 4B, the reference signs 15, 16, 17, 18 and 19 indicate an oblique stretching unit, a film feeding unit, a conveyance direction changing unit, a winding unit, and a film forming unit, respectively. It should be noted that, in FIGS. 3A to 3C and FIGS. 4A and 4B, the reference sign indicating one of the same elements or components is omitted in some cases.

Preferably, the film feeding unit 16 is configured to be slidable and swingable in such a manner as to feed a film at a given angle with respect to an inlet of the oblique stretching unit, or to be slidable in such a manner as to feed a film toward the inlet of the oblique stretching unit via the conveyance direction changing unit 17. FIGS. 3A to 3C illustrate three types in which an arrangement of the film feeding unit 16 and the conveyance direction changing unit 17 is variously changed. FIGS. 4A and 4B illustrate two types configured to feed a film formed by the film forming unit 19, directly to the oblique stretching unit. The film feeding unit 16 and the conveyance direction changing unit 17 are configured as illustrated in the figures. This makes it possible to reduce a width of the entire production apparatus, and finely control a position and an angle of the film feeding to thereby obtain a long stretched film having a small variation in film thickness and optical values. Further, each of the film feeding unit 16 and the conveyance direction changing unit 17 is configured to be movable. This makes it possible to effectively prevent defective biting of the right and left grippers into the film.

The winding unit 18 is disposed to draw the film at a given angle with respect to the oblique stretching unit 15. This makes it possible to finely control a position and an angle of the film drawing. As a result, a long stretched film having a small variation in film thickness and optical values can be obtained. Thus, it is possible to improve film windability while effectively preventing the occurrence of wrinkles of the film, thereby making it possible to wind up the film in a longer length. In this embodiment, a drawing tension T (N/m) of the stretched film is adjusted in the range of greater than 100 to less than 300 N/m, preferably, greater than 150 to less than 250 N/m.

[Melt Film-Forming Process]

The aforementioned retardation film may be formed by a melt film-forming process. The melt film-forming process is configured to melt a composition comprising a resin and an additive such as plasticizer by heating it up to a temperature providing its fluidity, and then cast the resulting melt containing a fluid thermoplastic resin.

A molding process based on heating and melting can be classified, for example, into a melt extrusion molding process, a press molding process, an inflation molding process, an injection molding process, a blow molding process and a draw molding process. Among these molding processes, a melt extrusion molding process is preferable from a viewpoint of mechanical strength and surface accuracy.

Generally, it is preferable that a plurality of raw materials for use in the melt extrusion molding process are preliminarily kneaded and pelletized. Pelletizing may be performed in a heretofore-known manner, for example, by: supplying dried cellulose ether, plasticizer and other additives to a single-screw or twin-screw extruder by using a feeder; kneading the mixture by the extruder; extruding the kneaded mixture from a die of the extruder to have a strand-like shape; water-cooling or air-cooling the extruded mixture; and cutting the cooled mixture.

The additives may be mixed before being supplied to the extruder, or may be supplied by independent feeders, respectively. Preferably, small amounts of additives such as fine particles and an antioxidant are preliminarily mixed therein to ensure uniform mixing.

Preferably, the extruder for use in pelletizing is a type capable of performing pelletizing at the lowest temperature allowing pelletizing, so as to suppress sharing force and prevent degradation of a resin (reduction in molecular weight, coloration, gelation, etc.). For example, in a twin-screw extruder, it is preferable to use deep-groove screws configured to be rotated in the same direction. In view of uniformity n kneading, an intermeshing type is preferably.

Film formation is performed using the pellets obtained in the above manner. It should be understood that the film formation may be performed just after a power of raw materials is directly put into a feeder without pelletizing, and then heated and melted.

A melting temperature during extrusion of the pellets by using a single-screw or twin-screw extruder is set in the range of 200 to 300° C. A resulting melt is filtrated using a leaf disk-type filter or the like to remove foreign substances therefrom, and cast from a T-die to have a film-like shape. Then, the melt is nipped between a cooling roller and an elastic touch roller, and solidified on the cooling roller.

Preferably, introduction from a feed hopper into the extruder is performed under vacuum or under reduced pressure or under an inert gas atmosphere, to thereby prevent oxidation, decomposition or the like.

Preferably, an extrusion flow rate is stabilized, for example, by means of introduction of a gear pump. As the filter for removing foreign substances, a sintered stainless steel fiber filter is preferably used. The sintered stainless steel fiber filter is obtained by: forming stainless steel fibers into a complicatedly tangled state; compressing the stainless steel fibers; and sintering contact portions of the compressed stainless steel fibers to integrate them together, wherein filtration accuracy can be adjusted by changing density of the fibers based on fiber diameter and compression amount.

The additives such as a plasticizer and fine particles may be preliminarily mixed with the resin, or may be kneaded into the resin in the course of the extrusion. For uniform addition, it is preferable to use a mixing device such as static mixer.

Preferably, a film temperature on the side of the touch roller during nipping of the film between the cooling roller and the elastic touch roller is set within the range of Tg of the film to Tg+110° C. As an elastic touch roller having an elastic surface usable for such a purpose, a heretofore-known elastic touch roller may be used. The elastic touch roller is also referred to as “nipping rotor”, and a commercially-available product may be used.

When the film is released from the cooling roller, it is preferable to control tension of the film to thereby prevent deformation of the film.

The film obtained in the above manner can be subjected to stretching and contracting through a stretching operation, after passing through the solidification step by means of contact with the cooling roller. For the stretching and contracting, the aforementioned heretofore-known roller stretching apparatus or oblique stretching apparatus can be preferably used. Generally, it is preferable that a stretching temperature is set in the range of Tg of a resin constituting the film to Tg+60° C.

Before wind-up, the film may be formed into a width of a final product by slitting and cutting off end portions thereof, and opposite ends thereof may be subjected to knurling (embossing) so as to prevent sticking or scratching during wind-up. The knurling may be achieved by means of heating and pressing of a metal ring having a convexo-concave pattern on a lateral surface thereof. Opposite lateral edge portions of the film which have been held by the clips (grippers) are cut off and recycled, because the edge portions are generally deformed and not usable as a final product.

The above retardation film is laminated to the aftermentioned polarizer in such a manner that an angle defined between the slow axis thereof and a transmission axis of the aftermentioned polarizer becomes substantially 45°, so as to form a circularly polarizing plate. As used in this specification, the term “substantially 45°” means an angle falling within the range of 40 to 50°.

The angle defined between the in-plane slow axis of the retardation film and the transmission axis of the aftermentioned polarizer is set preferably in the range of 41 to 49°, more preferably, in the range of 42 to 48°, further more preferably, in the range of 43 to 47°, particularly preferably, in the range of 44 to 46°.

<Circularly Polarizing Plate>

A circularly polarizing plate according to one embodiment of the present invention is produced by trimming edges of a roll of a long laminate comprising a long protective film, a long polarizer and the aforementioned long retardation film which are laminated in this order. In this circularly polarizing plate, the retardation film and the polarizer are bonded together by an active energy ray-curable adhesive. Thus, an obtainable circularly polarizing plate is free from a need for drying, and excellent in water resistance as compared to the case where the bonding is performed using liquid glue. Further, the retardation film constituting the circularly polarizing plate has excellent reverse wavelength dispersion characteristic, and therefore factions as a 214 retardation film exhibiting substantially λ/4 retardation in wide wavelength region. Therefore, an organic EL display using the circularly polarizing plate can suppress outside-light reflection and have enhanced contrast under bright conditions and black color reproducibility.

The circularly polarizing plate according to this embodiment employs the retardation film adjusted to allow an angle of the slow axis (i.e., orientation angle θ) with respect to a longitudinal direction thereof to become “substantially 45°”, so that it becomes possible to perform formation of an adhesive layer and lamination between a polarizer (polarizing film) and the retardation film in a roll-to-roll manner through a single continuous production line. Specifically, after completion of a step of producing a polarizing film through stretching, during or after a subsequent drying step, a step of laminating the retardation film to the polarizing film may be incorporated, wherein each of the polarizing film and the retardation film can be continuously supplied, and a resulting laminate can be wound up in a roll form to thereby allow this step to be linked with a next step through a single continuous production line. In the step of laminating the retardation film to the polarizing film, a protective film provided in a roll form may be simultaneously supplied and continuously laminated thereto. From a viewpoint of performance and production efficiency, it is preferable to simultaneously laminate the retardation film and the protective film to the polarizing film. That is, after completion of the step of producing a polarizing film through stretching, during or after the subsequent drying step, the retardation film and the protective film can be laminated, respectively, to opposite surfaces of the polarizing film to obtain a circularly polarizing plate, and the circularly polarizing plate can be formed into a roll.

<Active Energy Ray-Curable Adhesive>

As an adhesive, it is possible to use an active energy ray-curable adhesive. The use of the active energy ray-curable adhesive makes it possible to control moisture permeability of an obtainable retardation film. The retardation film according to this embodiment has a transmittance at a wavelength of 320 to 400 nm of 89% or more, as mentioned above. Thus, for example, when an UV adhesive, i.e., an active energy ray-curable adhesive, is interposed between the retardation film and the polarizer, and then UV light is emitted to the retardation film, the emitted UV light is transmitted through the retardation film to cause curing of the UV adhesive. As a result, the retardation film and the polarizer are bonded together.

In this embodiment, as the active energy ray-curable adhesive, it is possible to use a type containing: a cationically polymerizable compound (α); a photocationic polymerization initiator (β); a photosensitizer (γ) exhibiting a maximum absorption to light having a wavelength greater than 380 nm; and a naphthalene-based photosensitizer aid (δ).

(Cationically Polymerizable Compound (α))

The cationically polymerizable compound (α) is a primary component of an active energy ray-curable adhesive composition, and functions to impart an adhesive force by means of polymerization/curing. The cationically polymerizable compound (α) is not particularly limited as long as it is a compound curable by cation polymerization. For example, it is possible to use an epoxy compound having at least two epoxy groups in the molecule. Examples of such an epoxy compound include: an aromatic epoxy compound having an aromatic ring in the molecule; an alicyclic epoxy compound having at least two epoxy groups in the molecule, wherein at least one of the epoxy groups is bound to an alicyclic ring; and an aliphatic epoxy compound having no aromatic ring in the molecule and having a ring (usually, oxirane ring) containing an epoxy group and two carbon atoms bound thereto, wherein one of the carbon atoms is bound to another aliphatic carbon atom. In the active energy ray-curable adhesive in this embodiment, the cationically polymerizable compound (α) is particularly preferably composed mainly of an aromatic ring-free epoxy resin, or an alicyclic epoxy compound. The use of the cationically polymerizable compound composed mainly of an alicyclic epoxy compound can provide a cured product having a high storage elastic modulus, and, in a polarizing plate where the retardation film and the polarizer are bonded together through the cured product (adhesive layer), the polarizer becomes less likely to crack.

The alicyclic epoxy compound has at least two epoxy groups in the molecule, wherein at least one of the epoxy groups is bound to an alicyclic ring, as mentioned above. As used in this specification, the term “epoxy group bound to an alicyclic ring” means that, as represented in the following general formula (ep), two bonds of the epoxy group (—O—) are directly bound, respectively, to two carbon atoms (typically, adjacent carbon atoms) constituting the alicyclic ring. In the following general formula (ep), m represents an integer of 2 to 5.

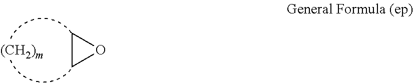

A compound in which a group in the general formula (ep) after removing one or more hydrogen atoms in (CH₂)ₘ is bound to another chemical structure can serve as the alicyclic epoxy compound. A hydrogen atom constituting the alicyclic ring may be appropriately substituted by a linear alkyl group, such as a methyl group or an ethyl group. In particular, a compound having an epoxycyclopentane ring (in the general formula (ep), m=3) or an epoxycyclohexane ring (in the general formula (ep), m=4) is preferable.

Among the above alicyclic epoxy compounds, a compound represented by any of the following formulas (ep-1) to (ep-11) is more preferable, because it is easily available and highly effective in enhancing the storage elastic modulus of the cured product.

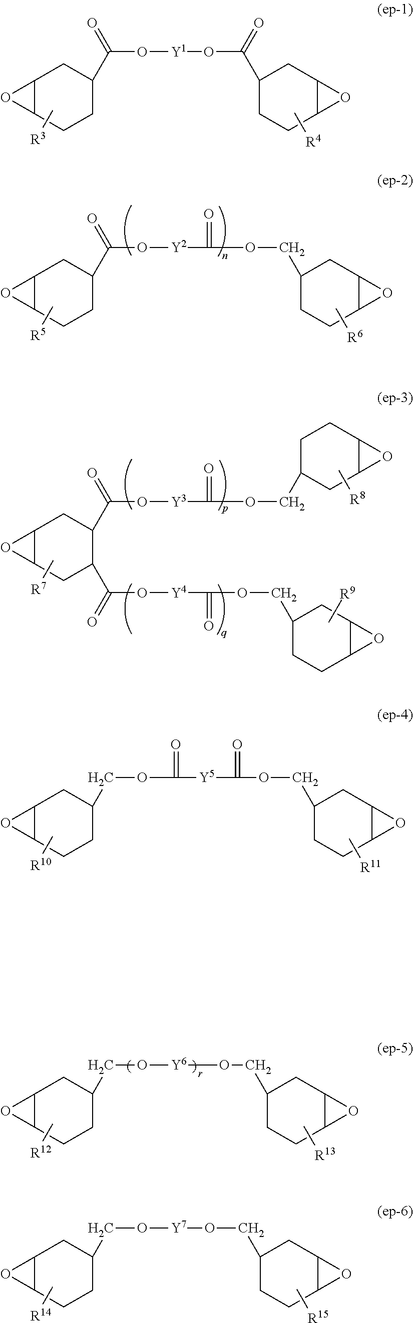

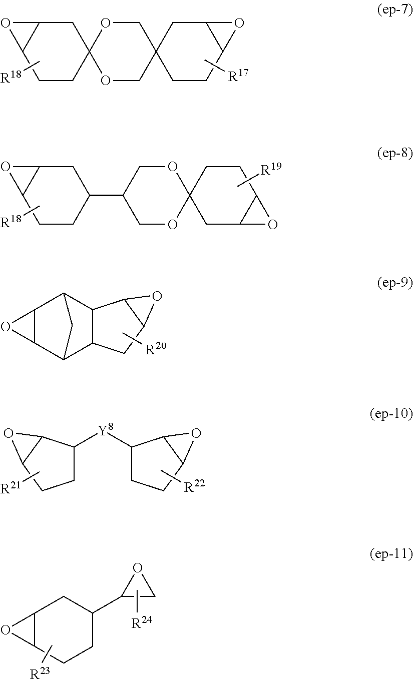

In the above formulas, R³ to R²⁴ each independently represents a hydrogen atom or a C₁₋₆ alkyl group, wherein, when each of R¹ to R²⁴ is an alkyl group, a position to be bound to the alicyclic ring is any of the positions 1 to 6. The C₁₋₆ alkyl group may be linear or branched, and may have an alicyclic ring. Y⁸ represents an oxygen atom or a C₁₋₂₀ alkanediyl group. Y¹ to Y⁷ each independently represents a C₁₋₂₀ alkanediyl group which may be linear or branched and may have an alicyclic ring. n, p, q, and r each independently represents any number of 0 to 20.

Among the compounds represented by the formulas (ep-1) to (ep-11), the alicyclic diepoxy compound represented by the formula (ep-2) is preferable, because it is easily available. The alicyclic diepoxy compound represented by the formula (ep-2) is an ester compound of 3,4-epoxycyclohexylmethanol (whose cyclohexane ring may be bound to a C₁₋₆ alkyl group) with 3,4-epoxycyclohexanecarboxylic acid (whose cyclohexane ring may be bound to a C₁₋₆ alkyl group). Specific examples of the ester compound include: 3,4-epoxycyclohexylmethyl-3,4-epoxycyclohexanecarboxylate (compound represented by the formula (ep-2), wherein R⁵=R⁶=H, and n=0); and 3,4-epoxy-6-methylcyclohexylmethyl-3,4-epoxy-6-methylcyclohexanecarboxylate (compound represented by the formula (ep-2), wherein R⁵=6-methyl, R⁶=6-methyl, and n=0).

Preferably, the alicyclic epoxy compound is used in combination with an epoxy resin having substantially no alicyclic epoxy group. The cationically polymerizable compound may be composed of a combination of the alicyclic epoxy compound used as a primary component and the epoxy resin having substantially no alicyclic epoxy group. In this case, it is possible to further enhance adherence between the polarizer and the retardation film while maintaining the high storage elastic modulus of the cured product. As used herein, the term “epoxy resin having substantially no alicyclic epoxy group” means a compound having a ring (typically, oxirane ring) containing an epoxy group and two carbon atoms bound thereto in the molecule, wherein one of the carbon atoms is bound to another aliphatic carbon atom. Examples of such a compound include polyglycidyl ether of polyalcohol (phenol). In particular, a diglycidyl ether compound represented by the following general formula (ge) is preferable, because it is easily available and highly effective in enhancing adherence between the polarizer and the retardation film.

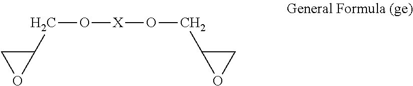

In the above formula, X represents a direct bond, a methylene group, a C₁₋₄ alkylidene group, an alicyclic hydrocarbon group, O, S. SO₂, SS, SO, CO, OCO, or a substituent selected from the group consisting of three substituents represented by the following formulas ge-1) to (ge-3), and the alkylidene group may be substituted by a halogen atom.

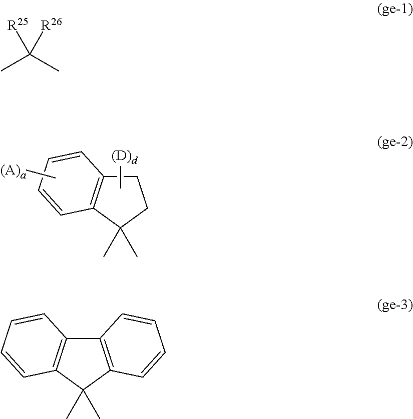

In the formula (ge-1), R²⁵ and R²⁶ each independently represents a hydrogen atom, a C₁₋₃ alkyl group, a phenyl group which may be substituted by a C₁₋₁₀ alkyl group or an alkoxy group, or a C₃₋₁₀ cycloalkyl group which may be substituted by a C₁₋₁₀ alkyl group or an alkoxy group. R²⁵ and R²⁶ may be linked to each other to form a ring.

In the formula (ge-2), A and D each independently represents a C₁₋₁₀ alkyl group which may be substituted by a halogen atom, a C₆₋₂₀ aryl group which may be substituted by a halogen atom, a C₇₋₂₀ arylalkyl group which may be substituted by a halogen atom, a C₂₋₂₀ heterocyclic group which may be substituted by a halogen atom, or a halogen atom. A methylene group in the alkyl, aryl and arylalkyl groups may be interrupted by an unsaturated bond, —O—, or —S—. “a” represents any number of 0 to 4, and “d” represents any number of 0 to 4.

Examples of the diglycidyl ether compound represented by formula (ge) include: bisphenol-type epoxy resins such as diglycidyl ether of bisphenol A, diglycidyl ether of bisphenol F, and diglycidyl ether of bisphenol S; polyfunctional epoxy resins such as glycidyl ether of tetrahydroxyphenylmethane, glycidyl ether of tetrahydroxybenzophenone, and epoxidized polyvinylphenol; polyglycidyl ethers of aliphatic polyalcohols; polyglycidyl ethers of alkylene oxide adducts of aliphatic polyalcohols; and diglycidyl ethers of alkylene glycols. Among them, polyglycidyl ether of an aliphatic polyalcohol is preferable.

Examples of the aliphatic polyalcohol include C₂₋₂₀ aliphatic polyalcohols. More specifically, the examples thereof include: aliphatic diols, such as ethylene glycol, 1,2-propanediol, 1,3-propanediol, 2-methyl-1,3-propanediol, 2-butyl-2-ethyl-1,3-propanediol, 1,4-butanediol, neopentyl glycol, 3-methyl-2,4-pentanediol, 2,4-pentanediol, 1,5-pentanediol, 3-methyl-1,5-pentanediol, 2-methyl-2,4-pentanediol, 2,4-diethyl-1,5-pentanediol, 1,6-hexanediol, 1,7-heptanediol, 3,5-heptanediol, 1,8-octanediol, 2-methyl-1,8-octanediol, 1,9-nonanediol, and 1,10-decanediol; alicyclic diols, such as cyclohexanedimethanol, cyclohexanediol, hydrogenated bisphenol A, and hydrogenated bisphenol F; and trivalent or higher polyols, such as trimethylolethane, trimethylolpropane, hexitols, pentitols, glycerin, polyglycerin, pentaerythritol, dipentaerythritol, and tetramethylolpropane.

In the case where the alicyclic epoxy compound and the epoxy resin having substantially no alicyclic epoxy group are used in combination, as regards content ratios thereof, the alicyclic epoxy compound and the epoxy resin having substantially no alicyclic epoxy group are preferably contained, respectively, in an amount of 50 to 95 mass % and in an amount of 5 mass % or more, with respect to a total amount of the cationically polymerizable compound. When the alicyclic epoxy compound is contained in an amount of 50 mass % or more, with respect to the total amount of the cationically polymerizable compound, a storage elastic modulus of a cured product at 80° C. reaches 1,000 MPa or more, so that a polarizing plate obtained by bonding the retardation film to the polarizer through such a cured product (adhesive layer) becomes less likely to crack. When the epoxy resin having substantially no alicyclic epoxy group is contained in an amount of 5 mass % or more, with respect to the total amount of the cationically polymerizable compound, adherence between the polarizer and the retardation film is enhanced. In the case where the cationically polymerizable compound is a binary compound of the epoxy resin having substantially no alicyclic epoxy group with the alicyclic epoxy compound, the epoxy resin is permitted to be contained in an amount of up to 50 mass %, with respect to the total amount of the cationically polymerizable compound. However, if the amount is excessively increased, the polarizer becomes more likely to crack due to a decrease in storage elastic modulus of the cured product. Thus, the amount of the epoxy resin is preferably set to 45 mass % or less, with respect to the total amount of the cationically polymerizable compound.

In the case of the alicyclic epoxy compound and the epoxy resin having substantially no alicyclic epoxy group are used in combination as the cationically polymerizable compound (α), the compound (α) may further contain an additional cationically polymerizable compound, while controlling respective contents of the two components to fall within the aforementioned ranges. Examples of the additional cationically polymerizable compound include epoxy compounds other than the compounds represented by the formulas (ep-1) to (ep-11) and (ge), and oxetane compounds.

Examples of the epoxy compounds other than the compounds represented by the formulas (ep-1) to (ep-11) and (ge) include: an alicyclic epoxy compound having, in the molecule, at least one epoxy group bound to an alicyclic ring, except the compounds represented by the formulas (ep-1) to (ep-11); an aliphatic epoxy compound having an oxirane ring bound to an aliphatic carbon atom, except the compounds represented by the formula (ge); an aromatic epoxy compound having am aromatic ring and an epoxy group in the molecule; and a hydrogenated epoxy compound which is an aromatic epoxy compound whose aromatic ring is hydrogenated.

Examples of the alicyclic epoxy compound having, in the molecule, at least one epoxy group bound to an alicyclic ring, except the compounds represented by the formulas (ep-1) to (ep-11) include diepoxides of vinylcyclohexenes, such as 4-vinylcyclohexene diepoxide, and 1,2:8,9-diepoxylimonene.

Examples of the aliphatic epoxy compound having an oxirane ring bound to an aliphatic carbon atom, except the compounds represented by the formula (ge) include triglycidyl ether of glycerin, triglycidyl ether of trimethylolpropane, and diglycidyl ether of polyethylene glycol.

Examples of the aromatic epoxy compound having am aromatic ring and an epoxy group in the molecule include glycidyl ether of an aromatic polyhydroxy compound having at least two phenolic hydroxy groups in the molecule. Specific examples thereof include diglycidyl ether of bisphenol A, diglycidyl ether of bisphenol F, diglycidyl ether of bisphenol S, and glycidyl ether of phenol novolac resin.

The hydrogenated epoxy compound which is an aromatic epoxy compound whose aromatic ring is hydrogenated can be obtained by subjecting an aromatic polyhydroxy compound having at least two phenolic hydroxy groups in the molecule serving as a raw material for the aromatic epoxy compound, to selective hydrogenation reaction under pressure in the presence of a catalyst to obtain a hydrogenated polyhydroxy compound, and glycidyletherifying the obtained hydrogenated polyhydroxy compound. Specific examples thereof include diglycidyl ether of hydrogenated bisphenol A, diglycidyl ether of hydrogenated bisphenol F, and diglycidyl ether of hydrogenated bisphenol S.

In the case where, among the epoxy compounds other than the compounds represented by the formulas (ep-1) to (ep-11) and (eg), a specific compound having epoxy group bound to an alicyclic ring and falling into the previously defined alicyclic epoxy group is added, it is preferable to use the specific compound in such a manner that a sum of the specific compound and the alicyclic epoxy compound represented by any of the formulas (ep-1) to (ep-11) is not greater than 95 mass %, with respect to the total amount of the cationically polymerizable compound.

The oxetane compound possibly serving as an optional cationically polymerizable compound is a compound having 4-membered ring ether (oxetanyl group) in the molecule. Specific examples thereof include: 3-ethyl-3-hydroxymethyloxetane: 1,4-bis[(3-ethyl-3-oxetanyl)methoxymethyl]benzene; 3-ethyl-3-(phenoxymethyl)oxetane; di[(3-ethyl-3-oxetanyl)methyl]ether; 3-ethyl-3-(2-ethylhexyloxymethyl)oxetane; 3-ethyl-3-(cyclohexyloxymethyl)oxetane; phenol novolac oxetane; 1,3-bis[(3-ethyloxetan-3-yl)methoxy]benzene: oxetanyl silsesquioxane; and oxetanyl silicate.

Preferably, the oxetane compound is contained in an amount of 30 mass % or less, with respect to the total amount of the cationically polymerizable compound. As long as it is contained in this range, curability is enhanced, as compared to the case where only the epoxy compound is use as the cationically polymerizable compound.

(Photocationic Polymerization Initiator (β))

In this embodiment, the aforementioned cationically polymerizable compound (α) is cationically polymerized and cured by means of irradiation with active energy rays to form an adhesive layer. Thus, a photocationic polymerization initiator (β) is preferably added to the active energy ray-curable adhesive composition.

Upon irradiation with active energy rays, such as visible rays, ultraviolet rays, X-rays, or electron rays, the photocationic polymerization initiator (β) generates cationic species or Lewis acid to cause a polymerization reaction of the cationically polymerizable compound (α) to be initiated. The photocationic polymerization initiator catalytically acts in response to light, so that it is excellent in storage stability and handleability even in the form of a mixture with the cationically polymerizable compound (α). Examples of such a compound capable of generating cationic species or Lewis acid upon irradiation with active energy rays include: aromatic diazonium salts; onium salts such as aromatic iodonium salts and aromatic sulfonium salts; and iron-allene complexes.

Examples of the aromatic diazonium salts include: benzenediazonium hexafluoroantimonate; benzenediazonium hexafluorophosphate; and benzenediazonium hexafluoroborate.

Examples of the aromatic iodonium salts include: diphenyliodonium tetrakis(pentafluorophenyl)borate; diphenyliodonium hexafluorophosphate; diphenyliodonium hexafluoroantimonate; and di(4-nonylphenyl)iodonium hexafluorophosphate.

Examples of the aromatic sulfonium salts include: triphenylsulfonium hexafluorophosphate; triphenylsulfonium hexafluoroantimonate; triphenylsulfonium tetrakis(pentafluorophenyl)borate; 4,4′-bis[diphenylsulfonio]diphenylsulfide bishexafluorophosphate; 4,4′-bis[di(β-hydroxyethoxy)phenylsulfonio]diphenylsulfide bishexafluoroantimonate; 4,4′-bis[di(β-hydroxyethoxy)phenylsulfonio]diphenylsulfide bishexafluorophosphate; 7-[di(p-toluoyl)sulfonio]-2-isopropylthioxanthone hexafluoroantimonate; 7-[di(p-toluoyl)sulfonio]-2-isopropylthioxanthone tetrakis(pentafluorophenyl)borate; 4-phenylcarbonyl-4′-diphenylsulfonio-diphenylsuffide hexafluorophosphate; 4-(p-tert-butylphenylcarbonyl)-4′-diphenylsulfonio-diphenylsulfide hexafluoroantimonate; and 4-(p-tert-butylphenylcarbonyl)-4′-di(p-toluoyl)sulfonio-diphenyl sulfide tetrakis(pentafluorophenyl)borate.

Examples of the iron-allene complexes include: xylene-cyclopentadienyl iron(II) hexafluoroantimonate; cumene-cyclopentadienyl iron(II) hexafluorophosphate; and xylene-cyclopentadienyl iron(II) tris(trifluoromethylsulfonyl)methanide.

These photocationic polymerization initiators (β) may be used independently or in the form of a mixture of two or more of them. Among them, aromatic sulfonium salts are particularly preferably used, because they have an ultraviolet ray-absorption property even in a wavelength region around 300 nm, and exhibit excellent curability to provide a cured product having good mechanical strength and adhesive strength.

The photocationic polymerization initiator (β) is contained preferably in an amount of 1 to 10 mass parts, more preferably, in an amount of 2 to 6 mass parts, with respect to 100 mass parts as the total amount of the cationically polymerizable compound (α). When the photocationic polymerization initiator is contained in an amount of 1 mass parts or more per 100 mass parts of the cationically polymerizable compound (α), it becomes possible to sufficiently cure the cationically polymerizable compound (α) to impart high mechanical strength and adhesive strength to an obtainable polarizing plate. On the other hand, if the content is greater than 10 mass parts, moisture permeability of a cured product becomes higher due to an increase in amount of ionic substances in the cured product, possibly causing deterioration in durability of a polarizing plate.

(Photosensitizer (γ))

In addition to the cationically polymerizable compound (α) containing the aforementioned epoxy compound, and the photocationic polymerization initiator (β), the active energy ray-curable adhesive in this embodiment contains the photosensitizer (γ) exhibiting a maximum absorption to light having a wavelength greater than 380 nm. The photocationic polymerization initiator (β) exhibits a maximum absorption at a wavelength around or less than 300 nm, and, can sensitively respond to light having a wavelength therearound to generate cationic species or Lewis acid to thereby cause cationic polymerization of the cationically polymerizable compound (α) to be initiated. With a view to allow the photocationic polymerization initiator (β) to sensitively respond to light having a longer wavelength, the photosensitizer (γ) exhibiting the maximum absorption to light having a wavelength greater than 380 nm is added.

As the photosensitizer (γ), it is preferable to use an anthracene-based compound represented by the following general formula (at).

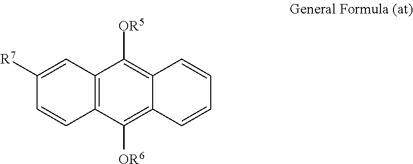

In this formula, R⁵ and R⁶ each independently represents a C₁₋₆ alkyl group or a C₂₋₁₂ alkoxyalkyl group. R⁷ represents a hydrogen atom or a C₁₋₆ alkyl group.

Specific examples of the anthracene-based compound represented by the general formula (III) include: 9,10-dimethoxyanthracene; 9,10-diethoxyanthracene; 9,10-dipropoxyanthracene; 9,10-diisopropoxyanthracene; 9,10-dibutoxyanthracene; 9,10-dipentyloxyanthracene; 9,10-dihexyloxyanthracene; 9,10-bis(2-methoxyethoxy)anthracene; 9,10-bis(2-ethoxyethoxy)anthracene; 9,10-bis(2-butoxyethoxy)anthracene; 9,10-bis(3-butoxypropoxy)anthracene; 2-methyl- or 2-ethyl-9,10-dimethoxyanthracene; 2-methyl- or 2-ethyl-9,10-diethoxyanthracene; 2-methyl- or 2-ethyl-9,10-dipropoxyanthracene; 2-methyl- or 2-ethyl-9,10-diisopropoxyanthracene; 2-methyl- or 2-ethyl-9,10-dibutoxyanthracene; 2-methyl- or 2-ethyl-9,10-dipentyloxyanthracene; and 2-methyl- or 2-ethyl-9,10-dihexyloxyanthracene.

When the aforementioned photosensitizer (γ) is added to the active energy ray-curable adhesive, the curability of the active energy ray-curable adhesive is enhanced, as compared to the case where it is not contained. The content of the photosensitizer (γ) with respect to 100 mass parts of the cationically polymerizable compound (α) constituting the active energy ray-curable adhesive may be set to 0.1 mass parts or more to provide enhanced curability. On the other hand, if the content of the photosensitizer (γ) is excessively increased, a problem such as precipitation during low-temperature storage is likely to occur. Thus, the content is preferably set to 2 mass parts or less, with respect to 100 mass parts of the cationically polymerizable compound (α). From a viewpoint of maintaining neutral gray of a polarizing plate, it is preferable to reduce the content of the photosensitizer (γ) to an extent capable of adequately maintaining adhesiveness between the polarizer and the retardation film. For example, the photosensitizer (γ) is contained preferably in an amount of 0.1 to 0.5 mass parts, more preferably, in an amount of 0.1 to 0.3 mass parts, with respect to 100 mass parts of the cationically polymerizable compound (α).

(Photosensitizer Aid (δ))

In addition to the cationically polymerizable compound (α) containing the epoxy compound, the photocationic polymerization initiator (β) and the photosensitizer (γ), the active energy ray-curable adhesive may contain the photosensitizer aid (δ) (hereinafter also referred to as “naphthalene-based photosensitizer aid (δ)”) represented by the following formula (nf).

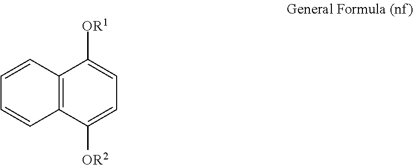

In this formula, R¹ and R² each represent a C₁₋₆ alkyl group.

Specific examples of the naphthalene-based photosensitizer aid (δ) include: 1,4-dimethoxynaphthalene; 1-ethoxy-4-methoxynaphthalene; 1,4-diethoxynaphthalene; 1,4-diprpoxynaphthalene; and 1,4-dibutoxynaphthalene.

When the naphthalene-based photosensitizer aid (δ) is added to the active energy ray-curable adhesive in this embodiment, the curability of the active energy ray-curable adhesive is enhanced, as compared to the case where it is not contained. The content of the naphthalene-based photosensitizer aid (δ) with respect to 100 mass parts of the cationically polymerizable compound (α) constituting the active energy ray-curable adhesive may be set to 0.1 mass parts or more to develop an advantageous effect of enhancing the curability. On the other hand, if the content of the naphthalene-based photosensitizer aid (δ) is excessively increased, a problem such as precipitation during low-temperature storage is likely to occur. Thus, the content is preferably set to 10 mass parts or less, or more preferably, 5 mass parts or less, with respect to 100 mass parts of the cationically polymerizable compound (α).

The active energy ray-curable adhesive in this embodiment may further contain an additive component as an optional or additional component, without impairing advantageous effects of this embodiment. As the additive component, it is possible to add a photosensitizer other than the photosensitizer (γ), a thermal cationic polymerization initiator, a polyol, an ion trapping agent, an antioxidant, a light stabilizer, a chain transfer agent, a tackifier, a thermoplastic resin, a filler, a flow adjuster, a plasticizer, an antifoaming agent, a leveling agent, a dye, an organic solvent, or the like, in addition to the photocationic polymerization initiator (β) and the photosensitizer (γ).

In case of using the additive component, the additive component is preferably contained in 1000 mass parts or less, with respect to 100 mass parts of the cationically polymerizable compound (α). As long as the content is 1000 mass parts or less, it is possible to bring out advantageous effects of the combination of the cationically polymerizable compound (α), the photocationic polymerization initiator (β), the photosensitizer (γ) and the naphthalene-based photosensitizer aid (δ) as essential components of the active energy ray-curable adhesive, i.e., enhancement in storage stability, prevention of color changing, enhancement in curing rate, and securing of good adhesiveness.

Preferable examples of a curable component of the active energy ray-curable adhesive in this embodiment include an N-substituted amide-based monomer having a hydroxy group. A substituent to be bound to a nitrogen atom (N) constituting an amide group may have at least one hydroxyl group, or may have two or more hydroxyl group. The N-substituted amide-based monomer having a hydroxy group may be monofunctional or may be bi- or higher-functional. A plurality of types of the N-substituted amide-based monomers each having a hydroxy group may be used independently or in the form of a combination of two or more of them.

The N-substituted amide-based monomer having a hydroxy group exhibits good adhesiveness, even with respect to a polarizer having a low moisture content or a retardation film using a low moisture permeable material. For example, N-substituted amide-based monomers, such as N-hydroxyethyl(meth)acrylamide, N-(2,2-dimethoxy-1-hydroxyethyl)-(meth)acrylamide, N-hydroxymethyl(meth)acrylamide, p-hydroxyphenyl(meth)acrylamide, and N,N′-(1,2-dihydroxyethylene)bis(meth)acryl amide, exhibit good adhesiveness. Among them, N-hydroxyethyl(meth)acrylamide is preferable. As used in this specification, the term “(meth)acrylamide” means an acrylamide group and/or a methacrylamide group.

As the curable component, an additional monomer may be contained, in addition to the N-substituted amide-based monomer having a hydroxy group. Examples of the additional monomer usable as the curable component include a compound having a (meth)acryloyl group, and a compound having a vinyl group. The additional monomer usable as the curable component may be may be monofunctional or may be bi- or higher-functional. The above curable components may be used independently or in the form of a combination of two or more of them.

For example, as the additional monomer usable as the curable component, it is preferable to use an N-substituted amide-based monomer other than the N-substituted amide-based monomer having a hydroxy group. This N-substituted amide-based monomer is represented by the following general formula.

CH₂═C(R₁)−CONR₂(R₃) General Formula (N)

In the general formula (N), R₁, R₂ and R₃ represent: a hydrogen atom or a methyl group; a hydrogen atom, a mercapto group, an amino group, or a C₁₋₄, linear or branched alkyl group which may have a quaternary ammonium group; and a hydrogen atom, or a C₁₋₄, linear or branched alkyl group, respectively, except that R₂ and R₃ are simultaneously hydrogen atoms. R₂ and R₃ may be bound to each other to form a 5-membered or 6-membered ring which may contain an oxygen atom.

In the general formula (N), examples of the C₁₋₄, linear or branched alkyl group in R₂ or R₃ include a methyl group, an ethyl group, an isopropyl group and a t-butyl group, and examples of the alkyl group having an amino group include an aminomethyl group, and an aminoethyl group. In the case where R₂ and R₃ are bound to each other to form a 5-membered or 6-membered ring which may contain an oxygen atom, the monomer comprises a heterocyclic ring having a nitrogen atom. Examples of the heterocyclic ring include a morpholine ring, a piperidine ring, a pyrrolidine ring, and a piperazine ring.

Specific examples of the N-substituted amide-based monomer includes N-methyl(meth)acrylamide, N,N-dimethyl(meth)acrylamide, N,N-diethyl(meth)acrylamide, N-isopropylacrylamide, N-butyl(meth)acrylamide, N-hexyl(meth)acrylamide, N-methylol(meth)acrylamide, N-methylol-N-propane(meth)acrylamide, aminomethyl(meth)acrylamide, aminoethyl(meth)acrylamide, mercaptomethyl(meth)acrylamide, and mercaptoethyl(meth)acrylamide. Examples of the heterocyclic monomer having a heterocyclic ring include N-acryl oylmorpholine, N-acryloylpiperidine, N-methacryloylpiperidine, and N-acryloylpyrrolidine. These N-substituted amide-based monomers may be used independently or in the form of a combination of two or more of them.

In the case where the N-substituted amide-based monomer having a hydroxy group, and the N-substituted amide-based monomer represented by the general formula (N) are used in combination as the curable component, a combination of N-hydroxyethyl(meth)acrylamide and N-acryloylmorpholine is suitable, from a viewpoint of durability, coatability and adhesiveness. In the above combination, a ratio of N-hydroxyethyl(meth)acrylamide to a total amount of N-hydroxyethyl(meth)acrylamide and N-acryloylmorpholine is preferably set to 40 mass % or more, from a viewpoint of obtaining good adhesiveness. The ratio of N-hydroxyethyl(meth)acrylamide to the total amount of N-hydroxyethyl(meth)acrylamide and N-acryloylmorpholine is more preferably 40 to 95 mass %, further more preferably, 60 to 90 mass %.

In addition to the above, examples of a monomer usable as the curable component in combination with the N-substituted amide-based monomer having a hydroxy group include, as a compound having a (meth)acryloyl group, various types of epoxy(meth)acrylates, urethane(meth)acrylates and polyester(meth)acrylates, and various types of (meth)acrylate monomers. Among them, epoxy(meth)acrylates, particularly, monofunctional (meth)acrylate having an aromatic ring and a hydroxyl group, are suitably used.

As the monofunctional (meth)acrylate having an aromatic ring and a hydroxyl group, various types of monofunctional (meth)acrylates each having an aromatic ring and a hydroxyl group may be used. While the hydroxyl group may exist as a substituent for the aromatic ring, it preferably exists as an organic group (hydrocarbon group, particularly, hydrocarbon group bound to an alkylene group) capable of binding the aromatic ring to the (meth)acrylate.

Examples of the monofunctional (meth)acrylates each having an aromatic ring and a hydroxyl group include a reaction product between a monofunctional epoxy compound having an aromatic ring and (meth)acrylic acid. Examples of the monofunctional epoxy compound having an aromatic ring include phenylglycidylether, t-butylphenylglycidylether, and phenyl polyethylene glycol glycidyl ether. Specific examples of the monofunctional (meth)acrylate having an aromatic ring and a hydroxyl group include 2-hydroxy-3-phenoxypropyl(meth)acrylate, 2-hydroxy-3-t-butyl phenoxypropyl(meth)acrylate, 2-hydroxy-3-t-butyl phenoxypropyl(meth)acrylate, 2-hydroxy-3-phenyl polyethylene glycol propyl(meth)acrylate.

Examples of the compound having a (meth)acryloyl group include a carboxylic monomer. The carboxylic monomer is also preferable, from a viewpoint of adhesiveness. Examples of the carboxylic monomer include (meth)acrylic acid, carboxyethyl(meth)acrylate, and carboxypentyl(meth)acrylate. Among them, an acrylic acid is preferable.

In addition to the above, examples of the compound having a (meth)acryloyl group further include: C₁₋₁₂ alkyl(meth)acrylates, such as methyl(meth)acrylate, ethyl(meth)acrylate, n-butyl(meth)acrylate, 2-ethylhexyl(meth)acrylate, isooctyl(meth)acrylate, isononyl(meth)acrylate, and lauryl(meth)acrylate; alkoxyalkyl(meth)acrylate-based monomers, such as methoxyethyl(meth)acrylate and ethoxyethyl(meth)acrylate; hydroxy group-containing monomers, such as 2-hydroxyethyl(meth)acrylate, 2-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate, and (4-hydroxymethyl cyclohexyl)-methyl acrylate; acid anhydride group-containing monomers, such as maleic acid anhydride, and itaconic acid anhydride; acrylic acid-caprolactone adducts; sulfonic acid group-containing monomers, such as styrenesulfonic acid, allylsulfonic acid, 2-(meth)acrylamide-2-methylpropanesulfonic acid, (meth)acrylamidepropanesulfonic acid, sulfopropyl(meth)acrylate, and (meth)acryloyloxynaphthalenesulfonic acid; and phosphoric group-containing monomers, such as 2-hydroxyethylacryloyl phosphate. They may be used alone or in combination. The examples also include: (meth)acrylamide; maleimide, N-cyclohexylmaleimide, N-phenylmaleimide or the like; alkylaminoalkyl(meth)acrylate based monomers, such as aminoethyl(meth)acrylate, aminopropyl(meth)acrylate, N,N-dimethylaminoethyl(meth)acrylate, t-butylaminoethyl(meth)acrylate, t-butylaminoethyl(meth)acrylate, and 3-(3-pyridinyl)propyl(meth)acrylate; and nitrogen-containing monomers, such as N-(meth)acryloyloxymethylene succinimide, N-(meth)acryloyl-6-oxyhexamethylene succinimide, and N-(meth)acryloyl-8-oxyoctamethylene succinimide.

In addition to the above curable components, a bi- or higher-functional curable component may also be used. As the bi- or higher-functional curable component, bi- or higher-functional (meth)acrylate, particularly, bi- or higher-functional epoxy(meth)acrylate, is preferable. The bi- or higher-functional epoxy(meth)acrylate is obtained through a reaction between a multifunctional epoxy compound and a (meth)acrylic acid. Various types of the multifunctional epoxy compounds can be exemplified. Examples of the multifunctional epoxy compound include an aromatic epoxy resin, an alicyclic epoxy resin, and an aliphatic epoxy resin.

Examples of the aromatic epoxy resin include: bisphenol-type epoxy resins, such as diglycidylether of bisphenol A, diglycidylether of bisphenol F, and diglycidylether of bisphenol S; novolac-type epoxy resins, such as phenol novolak epoxy resin, and cresol novolak epoxy resin, hydroxybenzaldehyde phenol novolak epoxy resin; and multifunctional epoxy resins, such as glycidyl ether of tetrahydroxyphenylmethane, glycidyl ether of tetrahydroxybenzophenone and epoxidized polyvinylphenol.

Examples of the alicyclic epoxy resin include a hydrogenerated product of the aromatic epoxy resin, a cyclohexane-based epoxy resin, a cyclohexylmethyl ester-based epoxy resin, a cyclohexylmethyl ether-based epoxy resin, a spiro-based epoxy resin, and a tricyclodecane-based epoxy resin.

Examples of the aliphatic epoxy resin include polyglycine ethers of aliphatic polyalcohols or alkylene oxide adducts thereof. Examples thereof include: diglycidylether of 1,4-butanediol; diglycidylether of 1,6-hexanediol; triglycidylether of glycerin; triglycidylether of trimethylolpropane; diglycidylether of polyethylene glycol; diglycidylether of propylene glycol; and polyglycidylether of polyether polyol obtained by adding one or more alkylene oxides (ethylene oxide, propylene oxide, etc.) to aliphatic polyalcohol such as ethylene glycol, propylene glycol or glycerin.

An epoxy equivalent of the epoxy resin is typically 30 to 3000 g/equivalent, preferably, 50 to 1500 g/equivalent.

As the bi- or higher-functional epoxy(meth)acrylate, epoxy(meth)acrylate of aliphatic epoxy resin is preferable, and epoxy(meth)acrylate of bifunctional aliphatic epoxy resin is particularly preferable.

The N-substituted amide-based monomer having a hydroxy group is used as the curable component in the active energy ray-curable adhesive. As a monomer to be used in combination therewith, the N-substituted amide-based monomer represented by the general formula (1) is preferable. In the case where the monofunctional (meth)acrylate having an aromatic ring and a hydroxyl group is concomitantly used as the curable component, the N-substituted amide-based monomer is contained preferably in an amount of 0 to 50 mass %, more preferably, 1 to 40 mass %, further more preferably, 5 to 30 mass %, with respect to a total amount of the N-substituted amide-based monomer having a hydroxy group.

In the case where the epoxy-based compound is used as a monomer to be concomitantly used, the N-substituted amide-based monomer is contained preferably in an amount of 0 to 50 mass %, more preferably, 1 to 30 mass %, further more preferably, 5 to 15 mass %, with respect to the total amount of the N-substituted amide-based monomer having a hydroxy group.

While the active energy ray-curable adhesive contains the above curable component, an additive may be appropriately added thereto, as needed. The active energy ray-curable adhesive can be used in the form of an electron ray-curable type or an ultraviolet ray-curable type. In the case where this adhesive is used in the form of an electron ray-curable type, there is not particularly a need for the adhesive to contain a photopolymerization initiator, whereas, in the case where it is used in the form of an ultraviolet ray-curable type, a photopolymerization initiator is use. The photopolymerization initiator is typically used in an amount of 0.1 to 10 mass parts, preferably, 0.5 to 3 mass pars, with respect to 100 mass parts of the curable component.

Examples of the additive include: a sensitizer for enhancing curing rate and curing sensitivity with respect to electron rays, typified by a carbonyl compound; an adhesion promoter typified by a silane coupling agent and an ethylene oxide; an additive for enhancing wettability with respect to the retardation film; an additive for enhancing mechanical strength and processibility, typified by an acryloyl group-containing compound and a hydrocarbon-based compound (natural or synthetic resin); an ultraviolet absorber; an anti-aging agent; a dye; a processing aid; an ion trapping agent; an antioxidant; a tackifier; a filler (other than metal compound fillers); a plasticizer; a leveling agent; an antifoaming agent; and an antistatic agent. Further, oxetane, polyol or the like may be contained.

<Production Method for Circularly Polarizing Plate>

A circularly polarizing plate can be produced by laminating the retardation film according to this embodiment to one surface of a polarizer through the use of an active energy ray-curable adhesive. In the case where the opposite surfaces of the retardation film are different in adhesiveness, it is desirable to laminate one of the surfaces having better adhesiveness to the polarizer. One example of a circularly polarizing plate production method using an active energy ray-curable adhesive will be described below.

A circularly polarizing plate can be produced by a production method comprising: an adhesive application step of applying an aftermentioned active energy ray-curable adhesive to at least one of bonding surfaces of a polarizer and the retardation film to form an adhesive layer; a lamination step of bonding and laminating the polarizer and the retardation film together through the adhesive layer; and a curing step of curing the adhesive layer in a state in which the polarizer and the retardation film are bonded together through the adhesive layer. The method may further comprise a pretreatment step of subjecting a surface of the retardation film to be bonded to the polarizer to easy-adhesion treatment.

(Pretreatment Step)

In the pretreatment step, a surface of the retardation film to be bonded to the polarizer is subjected to the easy-adhesion treatment. In the case where the retardation film and a protective film are bonded, respectively, to opposite surfaces of the polarizer, each of the retardation film and the protective film is subjected to the easy-adhesion treatment. In the subsequent adhesive application step, the easy-adhesion-treated surface is handled as a lamination surface with respect to the polarizer. Thus, one of opposite surfaces of the retardation film to be laminated to the active energy ray-curable adhesive is subjected to the easy-adhesion treatment. Examples of the easy-adhesion treatment include corona treatment and plasma treatment.

(Adhesive Application Step)

In the adhesive application step, the active energy ray-curable adhesive is applied to at least one of the bonding surfaces of the polarizer and the retardation film. In the case where the active energy ray-curable adhesive is applied directly to the surface of the polarizer or the retardation film, the application method is not particularly limited. For example, it is possible to use various wet application methods such as a doctor blade method, a wire bar method, a die coater method, a comma coater method, and a gravia coater method. It is also possible to use a technique of casting the active energy ray-curable adhesive between the polarizer and the retardation film and then evenly spreading the adhesive using a roller or the like.

(Lamination Step)

After applying the active energy ray-curable adhesive in the above manner, the films are subjected to the lamination step. For example, on an assumption that the active energy ray-curable adhesive is applied to the surface of the polarizer in the preceding application step, the retardation film is superposed on the surface of the polarizer in the lamination step. On the other had, on an assumption that the active energy ray-curable adhesive is applied to the surface of the retardation film in the preceding application step, the polarizer is superposed on the surface of the retardation film. In the case where the active energy ray-curable adhesive is cast between the polarizer and the retardation film, the polarizer and the retardation film are superposed in the cast state. Further, in the case where the retardation film and the protective film are to be bonded, respectively, to the opposite surfaces of the polarizer, and the active energy ray-curable adhesive is applied to each of the opposite surface of the polarizer, each of the retardation film and the protective film is superposed onto a respective one of the opposite surfaces of the polarizer through the active energy ray-curable adhesive. Then, in this state, a resulting laminate is pressed from opposite sides thereof (in the case where only the retardation film is superposed on one surface of the polarizer, from the sides of the polarizer and the retardation film, or in the case where the retardation film and the protective film are superposed, respectively, on the opposite surfaces of the polarizer, from the sides of the retardation film and the protective film) by rollers or the like. For example, as a material for the rollers, it is possible to use metal or rubber. The rollers to be disposed on the opposite sides may be formed of the same material or may be formed of different materials.

(Curing Step)

In the curing step, the active energy ray-curable adhesive in an uncured state is subjected to irradiation with active energy rays to cause the active energy ray-curable adhesive containing a cationically polymerizable compound (e.g., epoxy compound or oxetane compound) or a radically polymerizable compound (e.g., acrylate-based compound, acrylamide compound or the like) to be cured to thereby bond the superposed polarizer and retardation film or the superposed polarizer and retardation film, together, through the active energy ray-curable adhesive. In the case where only the retardation film is laminated to one surface of the polarizer, active energy rays may be emitted from either of the sides of the polarizer and the retardation film. On the other hand, in the case where the retardation film and the protective film are laminated, respectively, to the opposite surfaces of the polarizer, it is advantageous that, in a state in which the retardation film and the protective film are superposed, respectively, on the opposite surfaces of the polarizer through the active energy ray-curable adhesive, active energy rays are emitted in such a manner as to cause the active energy ray-curable adhesive on the opposite surfaces of the polarizer to be simultaneously cured.

As active energy rays to be used for curing, it is possible to use visible rays, ultraviolet rays, X-rays, electron rays or the like. Generally, electron rays or ultraviolet rays are preferably used, because they are easy to handle, and capable of achieving a sufficient curing rate.

As regards irradiation conditions for electron rays, any suitable condition may be employed as long as it allows for curing of the active energy ray-curable adhesive. For example, as regards electron ray irradiation, an acceleration voltage is set in the range of 5 to 300 kV, more preferably, 10 to 250 kV, If the acceleration voltage is less than 5 kV, electron rays are likely to fail to reach the adhesive, resulting in insufficient curing. On the other hand, if the acceleration voltage is greater than 300 kV, an ability to penetrate through a sample becomes excessively strong to cause bouncing of electron rays, possibly causing damage to the retardation film and the polarizer. An irradiation dose is set preferably in the range of 5 to 100 kGy, more preferably, 10 to 75 kGy. If the irradiation dose is less than 5 kGy, curing of the adhesive becomes insufficient. On the other hand, if it is greater than 100 kGy, problems, such as damage to the retardation film and the polarizer, deterioration in mechanical strength, and yellowing, are likely to occur, resulting in failing to obtain given optical properties.

As regards irradiation conditions for ultraviolet rays, any suitable condition may be employed as long as it allows for curing of the active energy ray-curable adhesive. An irradiation dose of ultraviolet rays is set preferably in the range of 50 to 1500 mJ/cm², more preferably, 100 to 500 mJ/cm².

In the case where the above production method is performed in a continuous line, depending on a curing time of the adhesive, a line speed is set in the range of 1 to 500 m/min, more preferably, 5 to 300 m/min, further more preferably, 10 to 100 m/min. If the line speed is excessively low, productively becomes poor, and damage to the retardation film is excessively large, tending to fail to produce a polarizing plate capable of bearing a durability test. On the other hand, if the like speed is excessively high, curing of the adhesive becomes insufficient, possibly failing to obtain intended adhesiveness.

In a polarizing plate obtained in the above manner, a thickness of the adhesive layer is not particularly limited, but may be typically in the range of 0.01 to 10 μm, preferably, 0.5 to 5 μm.

As above, in the circularly polarizing plate in this embodiment, the retardation film and the polarizer are bonded together by the active energy ray-curable adhesive. Thus, the polarizing plate is free from a need to be dried after bonding and is excellent in water resistance, as compared to the case where the retardation film and the polarizer are bonded together, for example, by using liquid glue.

<Organic EL Display>

An organic EL display according to one embodiment of the present invention is produced using the aforementioned circularly polarizing plate. More specifically, the organic EL display according to this embodiment comprises the circularly polarizing plate using the aforementioned retardation film, and an organic EL element. A screen size of the organic EL display is not particularly limited, but may be set to 20 inches or more.

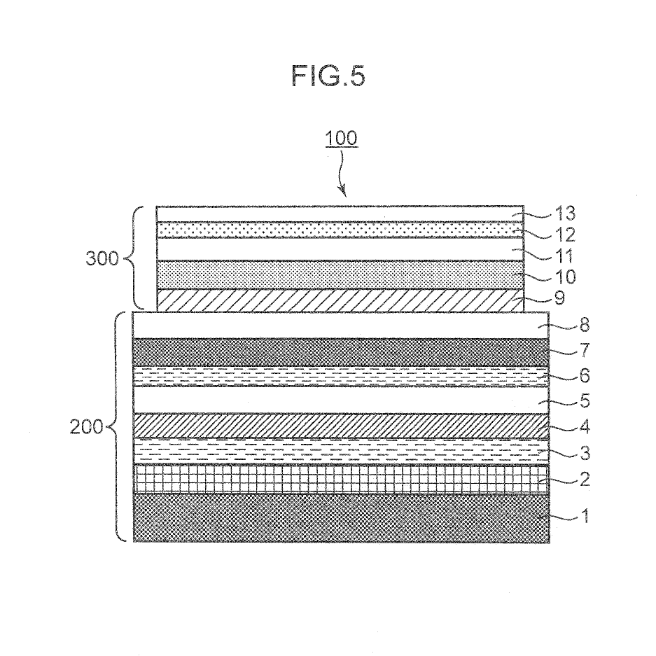

FIG. 5 is a schematic diagram of a configuration of the organic EL display according to this embodiment. It should be noted that the configuration of the organic EL display 100 illustrated in FIG. 5 is shown by way of example, and the configuration of the organic EL display according to this embodiment is not limited thereto.

As illustrated in FIG. 5, the organic EL display 100 is constructed by providing a circularly polarizing plate 10 on an organic EL element 200, wherein the organic EL element 200 comprises a metal electrode 2, a TFT (Thin Film Transistor) 3, an organic luminescent layer 4, a transparent electrode (such as ITO (Indium Tin Oxide)) 5, an insulation layer 6, a sealing layer 7 and a film 8 (which may be omitted) which are formed in this order on a transparent substrate 1 made, for example, of glass or polyimide, and the circularly polarizing plate 300 has a polarizer 10 sandwiched between the aforementioned retardation film 9 and a protective film 11. Preferably, a hardened layer 12 is laminated on the protective layer 11. The hardened layer 12 has not only an effect of preventing scratching of a surface of the organic EL display but also an effect of preventing warpage in the circularly polarizing plate. A reflection preventing layer 13 may be provided on the hardened layer. A thickness of the organic EL element itself is about 1 μm.

Generally, in an organic EL display, an element as a luminescent body (organic EL element) is formed by laminating a metal electrode, an organic luminescent layer and a transparent electrode onto a transparent substrate in this order. In this case, the organic luminescent layer is a laminate of various organic thin films. As such a laminate, there have been known various combinational laminates, such as: a laminate of a hole injection layer made, for example, of triphenylamine derivative, and a luminescent layer consisting of a fluorescent organic solid such as anthracene; a laminate of the luminescent layer, and an electron injection layer made, for example, of perylene derivative; and a laminate of the hole injection layer, the luminescent layer, and the electron injection layer.

The organic EL display can emit light based on a principle that, when a voltage is applied between the transparent electrode and the metal electrode, holes and electrons are injected into the organic luminescent layer and recombined to excite a fluorescent substance based on energy generated by the recombination, and then when the excited fluorescent substance returns to a ground state, it emits light. A mechanism of the recombination is the same as that in a commonly-used diode, and each of current and luminescence intensity exhibits a strong non-linearity involving rectification, with respect to an applied voltage.

In the organic EL display, in order to extract light emitted from the organic luminescent layer, it is necessary that at least one of two electrodes is transparent. Generally, it is preferable to use, as a positive electrode, a transparent electrode made of as a transparent electrically conductive material such as indium tin oxide (ITO). On the other hand, for facilitating electron injection to enhance luminous efficacy, it is important to use, as a negative electrode, a material having a relatively small work function. Generally, a metal electrode such as Mg—Ag or Al—Li is used.

The circularly polarizing plate with the aforementioned retardation film can be applied to an organic EL display with a wide screen having a screen size of 20 inch or more, i.e., a diagonal length of 50.8 cm or more.

In the organic EL display configured as above, the organic luminescent layer is formed as a layer having an extremely small thickness of about 10 mm Thus, the organic luminescent layer can fully transmit light therethrough, as with the transparent electrode. Thus, light entering from a front surface of the transparent substrate is transmitted through the transparent electrode and the organic luminescent layer and reflected by the metal electrode, and the reflected light is transmitted toward the front surface of the transparent substrate again. Thus, when viewed from the outside, a display screen of the organic EL display looks like a specular surface.

In an organic EL display having an organic EL element which comprises a transparent electrode provided on the side of a front surface of an organic luminescent layer capable of becoming luminous in response to voltage application, and a metal electrode provided on the side of a back surface of the organic luminescent layer, a polarizer may be provided on the side of a front surface (on a viewing side) of the transparent electrode, and a retardation plate may be provided between the transparent electrode and the polarizer.

The retardation film and the polarizer has a function of polarizing light reflected by the metal electrode after incoming from the outside, so that the polarization function can effectively prevent the specular surface of the metal electrode from being viewed from the outside. In particular, when the retardation film is composed of a quarter-wavelength retardation film, and an angle defined between polarization directions of the polarizer and the retardation film is adjusted to π/4, the specular surface of the metal electrode can be completely concealed.

That is, after external light enters into the organic EL display, only a linearly polarized component thereof is transmitted through the polarizer, and generally formed into elliptically polarized light through the retardation plate. Particularly when the retardation film is composed of a λ/4 retardation film, and an angle defined between polarization directions of the polarizer and the retardation film is π/4, the linearly polarized light is converted into circularly polarized light.

This circularly polarized light is transmitted through the transparent substrate, the transparent electrode and the organic thin film, and reflected by the metal electrode, and the reflected circularly polarized light is transmitted through the organic thin film, the transparent electrode and the transparent substrate, and re-converted into linearly polarized light through the retardation film. This linearly polarized light is orthogonal to the polarization direction of the polarizer, and thereby cannot be transmitted through the polarizer. Therefore, it becomes possible to completely conceal the specular surface of the metal electrode. Thus, the organic EL display according to this embodiment can suppress outside-light reflection, and provide excellent contrast under bright conditions and black color reproducibility.

This specification discloses various aspects of technical features as mentioned above. Among them, major technical features will be outlined below.

According to a first aspect of the present invention, there is provided a retardation film which comprises a cellulose ether derivative and a compound having a negative intrinsic birefringence, wherein the retardation film has: a transmittance at a wavelength of 320 to 400 nm of 89% or more; an in-plane retardation Ro₅₅₀ at a wavelength of 550 nm of 115 to 160 nm; and a ratio (Ro₄₅₀/Ro₅₅₀) of an in-plane retardation Ro₄₅₀ at a wavelength of 450 nm to the Ro₅₅₀ of 0.72 to 0.94.

The retardation film according to the first aspect of the present invention comprises the cellulose ether derivative, so that it becomes possible to facilitate development of retardation, and reduce a change in optical value (retardation) in a high-humidity environment. The retardation film also comprises the compound having a negative intrinsic birefringence (negative intrinsic birefringent compound), so that a reverse wavelength dispersion characteristic is imparted. Further, the negative intrinsic birefringent compound is less likely to cause deterioration in the transmittance at a wavelength of 320 to 400 nm, under coexistence with the cellulose ether derivative. Thus, an obtainable retardation film has a high transmittance at a wavelength of 320 to 400 nm, and can excellently transmit UV light therethrough. As a result, the retardation film can be bonded to a polarizer via an adhesive having an optical functional group (active energy ray-curable adhesive) by means of irradiation with UV light. In addition, the retardation film has excellent reverse wavelength dispersion characteristic, so that it is suitably usable, as a λ/4 retardation film exhibiting substantially λ/4 retardation in wide wavelength range, in a circularly polarizing plate for an organic EL display or the like.

Preferably, in the above retardation film, the negative intrinsic birefringent compound is a polymer having a weight-average molecular weight of 800 to 20000.

The negative intrinsic birefringent compound having such a weight-average molecular weight exhibits excellent compatibility with the cellulose ether derivative. This facilitates enhancement in the transmittance at a wavelength of 320 to 400 nm in an obtainable retardation film. This allows UV light to irradiate the active energy ray-curable adhesive so as to adequately bond the retardation film to a polarizer.

Preferably, in the above retardation film, the polymer is one or more oligomer selected from the group consisting of an oligomer comprising a styrene derivative structure, an oligomer comprising a maleimide derivative structure, an acrylonitrile-based oligomer, and a polymethylmethacrylate-based oligomer.

These oligomers have excellent compatibility with the cellulose ether derivative. This facilitates enhancement in the transmittance at a wavelength of 320 to 400 nm in an obtainable retardation film. This allows UV light to irradiate the active energy ray-curable adhesive so as to adequately bond the retardation film to a polarizer.

Accordingly to a second aspect of the present invention, there is provided a circularly polarizing plate which comprises: the above retardation film; and a polarizer, wherein the retardation film and the polarizer are bonded together by using an active energy ray-curative adhesive.

In the circularly polarizing plate accordingly to the second aspect of the present invention, the retardation film d the polarizer are bonded together by using an active energy ray-curative adhesive. Thus, the circularly polarizing plate is free from a need for drying, and excellent in water resistance as compared to the case where the bonding is performed using liquid glue. Further, the retardation film constituting the circularly polarizing plate has excellent reverse wavelength dispersion characteristic, and therefore functions as a λ/4 retardation film exhibiting substantially λ/4 retardation in wide wavelength region. Therefore, an organic EL display using the circularly polarizing plate can suppress outside-light reflection and have enhanced contrast under bright conditions and black color reproducibility.

Accordingly to a third aspect of the present invention, there is provided an image display device which comprises the above circularly polarizing plate.

The image display device (including an organic EL display) accordingly to the third aspect of the present invention comprises the above circularly polarizing plate, so that it becomes possible to suppress outside-light reflection and have enhanced contrast under bright conditions and black color reproducibility.

### EXAMPLES

The present invention will be specifically described below with reference to examples. It should be understood that the present invention is not limited thereto. The unit representations “part(s)” and “%” used in the following examples denote “mass part(s)” and “mass %”, respectively, unless otherwise noted.

Used materials are presented as follows.

<Resin Component>

(Cellulose Ether Derivative 1)

Commercially available ethylcellulose, total substitution degree: 2.35, weight-average molecular weight: 160,000

(Cellulose Ether Derivative 2)

Commercially available ethylcellulose, total substitution degree: 2.6, weight-average molecular weight: 180,000

(Cellulose Ether Derivative 3)

Commercially available ethylcellulose, total substitution degree: 2.4, weight-average molecular weight: 190,000

(Cellulose Ester Derivative)

Acetyl group-substituted ethylcellulose, total substitution degree: 2.2, weight-average molecular weight: 150,000

<Additives>

(Negative Intrinsic Birefringent Compound 1)

In a reactor, 1.0 mass part of styrene, 2.0 mass parts of acryloylmorpholine, 10 mass parts of toluene, and 0.05 mass parts of azobisisobutyronitrile were added, and heated to 80° C. After completion of polymerization, a resulting reaction solution was put into a large amount of hexane to separate a copolymerized oligomer, and the copolymerized oligomer was subjected to filtration, washing and drying to obtain a compound. This copolymer was subjected to GPC analysis on the basis of reference polystyrene. As a result, a weight-average molecular weight thereof was determined as 9,000. Further, from an NMR spectrum, it was determined that this compound was a copolymer of styrene and acryloylmorpholine, and its composition was approximately styrene:acryloylmorpholine=40:60.

(Negative Intrinsic Birefringent Compound 2)

In a reactor, 1.0 mass part of styrene, 2.0 mass parts of acryloylmorpholine, 10 mass parts of toluene, and 0.02 mass parts of azobisisobutyronitrile were added, and heated to 80° C. After completion of polymerization, a resulting reaction solution was put into a large amount of hexane to separate a copolymerized oligomer, and the copolymerized oligomer was subjected to filtration, washing and drying to obtain a compound. This copolymer was subjected to GPC analysis on the basis of reference polystyrene. As a result, a weight-average molecular weight thereof was determined as 2,000. Further, from an NMR spectrum, it was determined that this compound was a copolymer of styrene and acryloylmorpholine, and its composition was approximately styrene:acryloylmorpholine=70:30.

(Negative Intrinsic Birefringent Compound 3)

In a reactor, 1.0 mass part of styrene, 2.0 mass parts of acryloylmorpholine, 10 mass parts of toluene, and 0.06 mass parts of azobisisobutyronitrile were added, and heated to 80° C. After completion of polymerization, a resulting reaction solution was put into a large amount of hexane to separate a copolymerized oligomer, and the copolymerized oligomer was subjected to filtration, washing and drying to obtain a compound. This copolymer was subjected to GPC analysis on the basis of reference polystyrene. As a result, a weight-average molecular weight thereof was determined as 15,000. Further, from an NMR spectrum, it was determined that this compound was a copolymer of styrene and acryloylmorpholine, and its composition was approximately styrene:acryloylmorpholine=30:70.

(Negative Intrinsic Birefringent Compound 4)

In a reactor, 1.5 mass parts of styrene, 1.5 mass parts of acryloylmorpholine, 10 mass parts of toluene, and 0.04 mass parts of azobisisobutyronitrile were added, and heated to 80° C. After completion of polymerization, a resulting reaction solution was put into a large amount of hexane to separate a copolymerized oligomer, and the copolymerized oligomer was subjected to filtration, washing and drying to obtain a compound. This copolymer was subjected to GPC analysis on the basis of reference polystyrene. As a result, a weight-average molecular weight thereof was determined as 25,000. Further, from an NMR spectrum, it was determined that this compound was a copolymer of styrene and acryloylmorpholine, and its composition was approximately styrene:acryloylmorpholine=50:50.

(Negative Intrinsic Birefringent Compound 5)

In a reactor, 1.0 mass part of N-phenylmaleimide, 2.0 mass parts of acryloylmorpholine, 10 mass parts of toluene, and 0.01 mass parts of azobisisobutyronitrile were added, and heated to 80° C. After completion of polymerization, a resulting reaction solution was put into a large amount of hexane to separate a copolymerized oligomer, and the copolymerized oligomer was subjected to filtration, washing and drying to obtain a compound. This copolymer was subjected to GPC analysis on the basis of reference polystyrene. As a result, a weight-average molecular weight thereof was determined as 20,000. Further, from an NMR spectrum, it was determined that this compound is a copolymer of N-phenylmaleimide and acryloylmorpholine, and its composition is approximately N-phenylmaleimide:acryloylmorpholine=40:60.

(Negative Intrinsic Birefringent Compound 6)

In a reactor, 0.6 mass parts of p-acetoxystyrene, 1.0 mass parts of acryloylmorpholine, 10 mass parts of toluene, and 0.05 mass parts of azobisisobutyronitrile were added, and heated to 80° C. After completion of polymerization, a resulting reaction solution was put into a large amount of hexane to separate a copolymerized oligomer, and the copolymerized oligomer was subjected to filtration, washing and drying to obtain a compound. This copolymer was subjected to GPC analysis on the basis of reference polystyrene. As a result, a weight-average molecular weight thereof was determined as 4,000. Further, from an NMR spectrum, it was determined that this compound is a copolymer of p-acetoxystyrene and acryloylmorpholine, and its composition is approximately p-acetoxystyrene acryloylmorpholine=30:70.

(Negative Intrinsic Birefringent Compound 7)

Polystyrene (produced by Sigma-Alidrich Japan G.K., weight-average molecular weight: 800)

(Negative Intrinsic Birefringent Compound 8)

A compound was synthesized using the method described in JP 2008-107767A. A chemical formula of the obtained compound is presented as follows.

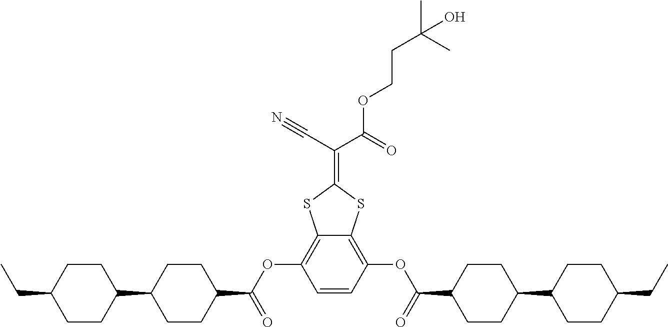

(Negative Intrinsic Birefringent Compound 9)

In a reactor, 1.0 mass part of 4-vinylbiphenyl, 2.0 mass parts of acryloylmorpholine, 10 mass parts of toluene, and 0.05 mass parts of azobisisobutyronitrile were added, and heated to 80° C. After completion of polymerization, a resulting reaction solution was put into a large amount of hexane to separate a copolymerized oligomer, and the copolymerized oligomer was subjected to filtration, washing and drying to obtain a compound. This copolymer was subjected to GPC analysis on the basis of reference polystyrene. As a result, a weight-average molecular weight thereof was determined as 9,000. Further, from an NMR spectrum, it was determined that this compound is a copolymer of 4-vinylbiphenyl and acryloylmorpholine, and its composition is approximately 4-vinylbiphenyl:acryloylmorpholine=40:60.

### Inventive Example 1

### Production of Retardation Film 1

(Preparation of Fine-Particle Dispersion Liquid)

| | |
|---|---|
| Fine particles (Aerosil R812; produced by | 11 mass parts |
| Nippon Aerosil Co., Ltd.) | |
| Ethanol | 89 mass parts |

They were stirred and mixed by using a dissolver for 50 minutes, and then dispersed by using Manton-Gaulin disperser to prepare a fine-particle dispersion liquid.

(Preparation of Fine-Particle Added Solution)

50 mass parts of methylenechloride was put in a dissolution tank, and then 50 mass parts of the prepared fine-particle dispersion liquid was slowly added to the methylenechloride under sufficient stirring. Further, the solution was subjected to dispersion using an attritor to allow secondary particles to have a particle size of 0.01 to 1.0 μm. The resulting solution was subjected to filtration using FINEMET NF produced by Nippon Seisen Co., Ltd., to prepare a fine-particle added solution.

(Preparation of Dope)

Firstly, methylenechloride and ethanol were added as an organic solvent into a pressurized dissolution tank in respective aftermentioned amounts. The cellulose ether derivative 1 was put in the pressurized dissolution tank containing the organic solvent, under stirring. The resulting mixture was completely solved under stirring, and then filtrated using a filter paper Azumi No. 244 produced by Azumi Filterpaper Co., Ltd to prepare a main dope. Then, the negative intrinsic birefringent compound 1 and the prepared fine-particle added solution were put into a main dissolving pan at the following ratio. After hermetically sealing the pan, the resulting mixture was solved under steering to prepare a dope solution.

<Composition of Dope>

| | |
|---|---|
| Methylenechloride | 466 mass parts |
| Ethanol | 41 mass parts |
| Cellulose ether derivative 1 | 100 mass parts |
| Negative intrinsic birefringent compound 1 | 15 mass parts |
| Fine-particle added solution | 1 mass parts |

(Film Formation)

The dope prepared in the above manner was cast on a stainless belt support, and the solvent was vaporized until a resultant solvent amount in the cast film became 75 mass %. Then, the film was peeled off from the stainless steel belt support with a peeling or pulling force of 130 N/m.

The peeled film was heated at 145° C. and uniaxially stretched only in a width direction (TD direction) at a stretching rate of 1% by using a stretching apparatus, in a state in which a conveyance tension was adjusted to prevent the film from being contracted in a conveyance direction (MD direction). The resultant solvent amount at a start of the stretching was 8 mass %. Then, the film conveyed via a large number of rollers through a drying zone, and completely dried. A drying temperature was set to 105° C., and the conveyance tension was set to 100 N/m. In this way, a resin film wound up into a roll was produced.

(Stretching Step)

The resin film was fed from the roll thereof, and the fed resin film was obliquely stretched using the obliquely stretching apparatus illustrated in FIG. 2, at a stretching temperature of 150° C. and at a stretching ratio of 1.8, under a condition that the bending angle θ and the contraction ratio were adjusted to allow an orientation axis to become 45°. In this manner, a λ/4 retardation film 1 having a film thickness of 40 μm was produced.

### Inventive Examples 2 to 10 and Comparative Examples 1 to 4

Except that the resin component and the additive were selected according to Table 1, retardation films 2 to 14 were produced in the same manner as that in the retardation film 1.

<Measurement of Property Values of Retardation Film>

Using a spectrophotometer V-7100 (produced by Jusco Co., Ltd.), a transmittance of each film at a wavelength of 320 to 400 nm was measured. A minimum transmittance at a certain wavelength is presented in Table 1.

<Measurement of In-Plane Retardations Ro₅₅₀, Ratio Ro₄₅₀/Ro₅₅₀>

For each of the retardation films 1 to 14 produced in the above manner, in-plane retardations Ro₄₅₀ and Ro₅₅₀ at respective wavelengths 450 nm and 550 were measured by using Axoscan produced by Axometrics Inc., in a 23° C. and 55% RH environment, and Ro₄₅₀/Ro₅₅₀ was calculated. The orientation angle was also measured by using Axoscan produced by Axometrics Inc. Results are presented in Table 1.

(Resistance to Retardation Change)

After each of the retardation films 1 to 14 produced in the above manner was subjected to humidity conditioning at 23° C. and 55% RH for 5 hours, an in-plane retardation Ro at a wavelength 550 nm was measured in the same environment, wherein the measurement result was defined as Ro₅₅% (550). After the same film was continuously immersed in pure water for 24 hours, the film impregnated with water was sandwiched between glass sheets to measure a Ro value, wherein the measured value was defined as Ro_{H2O} (550). Then, a change ratio ΔRo (550)(%) was calculated according to the following formula.

ΔRo(550)(%)=|Ro_{55%}(550)−Ro_{H2O}(550)|/Ro_{55%}(550)

Further, the sample was subjected to measurement in the 23° C. and 55% RH environment again, to ascertain that this change is invertible. A smaller value of ΔRo (550) (%) indicates that the film is more stable with respect to changes in moisture. The resistance to retardation change was evaluated, according to the following criteria.
⊚: ΔRo (550) (%) was 6% or less
o: ΔRo (550) (%) was in the range of greater than 6% to 10%
x: ΔRo (550) (%) was greater than 10%

(Resistance to Breed-Out)

After each of the retardation films 1 to 14 produced in the above manner was left in a high-temperature and high-humidity environment, specifically at 80° C. and 90% RH, for 100 hours, to evaluate the presence or absence of breed-out. The surface of the film was visually confirmed and evaluated the presence or absence of breed-out.
o: No breed-out occurred on a film surface
Δ: Breed-out was slightly observed on a part of the film surface at a practically negligible level
x: Breed-out was clearly observed on the film surface

<Production of Circularly Polarizing Plate>

(Production of Polarizer)

A 30 μm-thick polyvinyl alcohol film was swelled by water at 35° C. The obtained film was immersed in an aqueous solution consisting of 0.075 g of iodine, 5 g of potassium iodide and 100 g of water, for 60 seconds, and further immersed in an aqueous solution consisting of 3 g of potassium iodide, 7.5 g of boric acid and 100 g of water and having a temperature of 45° C. The obtained film retched film was subjected to uniaxial stretching at a stretching temperature of 55° C. and at a stretching ratio of 5 times. The uniaxially stretched film was subjected to water washing and drying to obtain a 10 μm-thick polarizer.

(Preparation of Active Energy Ray-Curable Adhesive: Cationically Polymerizable Type)

The following components were mixed and then defoamed to prepare a active energy ray-curable adhesive solution. Triarylsulfonium hexafluorophosphate was added as a 50% propylenecarbonate solution and indicated below by a solid content of propylenecarbonate.

| | |
|---|---|
| 3,4-Epoxycyclohexylmethyl | 45 mass parts |
| 3,4-epoxycyclohexanecarboxylate: | |
| Epolead GT-301 (manufactured by Daicel Corp., | 40 mass parts |
| alicyclic epoxy resin): | |
| 1,4-Butanediol diglycidyl ether: | 15 mass parts |
| Triarylsulfonium hexafluorophosphate: | 2.3 mass parts |
| 9,10-Dibutoxyanthracene: | 0.1 mass parts |
| 1,4-Diethoxynaphthalene: | 2.0 mass parts |

(Production of Polarizer 1)

As a protective film, KC6UA film (produced by Konica Minolta Opto, Inc) was prepared and coated with the prepared active energy ray-curable adhesive solution by using a micro gravure coater (gravure roller: #300, rotational speed: 140%/line speed) to form an active energy ray-curable adhesive layer having a film thickness of 5 μm. Then, in the same manner, the produced retardation film 1 was coated with the prepared active energy ray-curable adhesive solution to form an active energy ray-curable adhesive layer having a film thickness of 5 μm. The produced polyvinyl alcohol-iodine based polarizer was disposed between the active energy ray-curable adhesive layer formed on the KC6UA film and the active energy ray-curable adhesive layer formed on the retardation film 1, and they were laminated together using a roller machine to obtain a laminate of KC6UA/active energy ray-curable adhesive layer/polarizer/active energy ray-curable adhesive layer/retardation film 1 which are laminated in this other. In this process, the retardation film and the polarizer were laminated by the roller machine to allow a slow axis of the retardation film and an absorption axis of the polarizer to be arranged at an angle of 45° therebetween. Electron rays were emitted from opposite sides of the laminate t produce a polarizing plate 1. The line speed, the acceleration voltage and the irradiation dose were set, respectively, to 20 m/min, 250 kV and 20 kGy.

[Evaluation of Polarizing Plate 1]

The produced polarizing plate was cut into a square shape having a size of 5 cm×5 cm. The cut sample was left in the 23° C. and 55% RH environment for 24 hours, and then the retardation or protective film was peeled from a corner thereof along an interface with the polarizer. This operation was performed for 10 polarizing plates in each of the different types of samples, and the number of polarizing plates in which peeling between the polarizer and the film was observed was counted. Adhesion of the polarizer is desirable to be “o” or better.
o: No peeling occurred in 10 polarizing plates
x: Peeling was observed in one or more of the polarizing plates

[Production of Organic EL Display 1]

(Production of Organic EL Cell)

Using a 3 mm-thick alkali-free glass for 50 inches (127 cm), an organic EL cell having a configuration described in FIG. 8 of JP 2010-20925A, according to the method described in Examples in this patent publication was produced.

(Production of Organic EL Display 1)

After applying an adhesive on the retardation film of the polarizing plate 1 produced in the above manner, the retardation film is laminated to a viewing side of the organic EL cell to produce an organic EL display 1.

[Evaluation of Organic EL Display 1]

The organic EL display 1 produced in the above manner was evaluated as follows.

<Black Color Reproducibility>

In the 23° C. and 55% RH environment, a black color image was displayed on the organic EL display 1 under a condition that an illumination intensity at a position higher than an outermost surface of the organic EL display 1 by 5 cm became 1000 Lx. As regards the displayed black color image, respective viewabilities from a front position with respect to the surface the organic EL display 1 (an oblique angle of 0° with respect to a normal line to the surface, and an oblique angle of 40° with respect to the normal line were evaluated by 10 third-party evaluators, according to the following criteria. When the viewability was evaluated as A or better, it was determined to be practicable.
⊚: 8 or more evaluators determined that the image was black
o: 6 or more evaluators determined that the image was black
x: 5 or less evaluators determined that image was black

[Polarizing Plates 2 to 14]

Except that the optical film 1 was changed to one of optical films 2 to 14 during production of the polarizing plate 1, polarizing plates 2 to 14 were produced in the same manner.

[Evaluation of Organic EL Displays 2 to 12]

Except that the polarizing plate 1 was changed to one of polarizing plates 2 to 12 during production of the organic EL display 1, organic EL displays 2 to 12 were produced in the same manner. Then, the organic EL displays were evaluated in the same manner as that in Inventive Example 1. It should be noted that the polarizing plates 13, 14 could not be used for producing organic EL displays, due to their poor adhesiveness.

TABLE 1

| | | Additive | | | Trans- | | | | | | Black color |
|---|---|---|---|---|---|---|---|---|---|---|---|
| | | | | Amount | mit- | | | Retar- | | | repro- |
| | Resin | | | (mass | tance | | Ro₄₅₀/ | dation | Bleed- | Adhe- | duc- |
| | Component | Type | Mw | part) | (%) | Ro₅₅₀ | Ro₅₅₀ | change | out | sion | ibility |
| Inventive | Cellulose ether | Negative intrinsic birefringent | 9000 | 15 | 90 | 140 | 0.87 | ⊚ | ◯ | ◯ | ⊚ |
| Example 1 | derivative 1 | compound 1 | | | | | | | | | |
| Inventive | Cellulose ether | Negative intrinsic birefringent | 9000 | 9 | 91 | 155 | 0.92 | ⊚ | ◯ | ◯ | ⊚ |
| Example 2 | derivative 2 | compound 1 | | | | | | | | | |
| Inventive | Cellulose ether | Negative intrinsic birefringent | 9000 | 20 | 89 | 130 | 0.85 | ⊚ | ◯ | ◯ | ⊚ |
| Example 3 | derivative 3 | compound 1 | | | | | | | | | |
| Inventive | Cellulose ether | Negative intrinsic birefringent | 2000 | 20 | 90 | 125 | 0.84 | ⊚ | ◯ | ◯ | ⊚ |
| Example 4 | derivative 1 | compound 2 | | | | | | | | | |
| Inventive | Cellulose ether | Negative intrinsic birefringent | 15000 | 15 | 89 | 145 | 0.91 | ⊚ | ◯ | ◯ | ⊚ |
| Example 5 | derivative 1 | compound 3 | | | | | | | | | |
| Inventive | Cellulose ether | Negative intrinsic birefringent | 25000 | 15 | 90 | 140 | 0.89 | ◯ | Δ | ◯ | ⊚ |
| Example 6 | derivative 1 | compound 4 | | | | | | | | | |
| Inventive | Cellulose ether | Negative intrinsic birefringent | 9000 | 8 | 90 | 160 | 0.92 | ⊚ | ◯ | ◯ | ◯ |
| Example 7 | derivative 1 | compound 1 | | | | | | | | | |
| Inventive | Cellulose ether | Negative intrinsic birefringent | 20000 | 25 | 89 | 123 | 0.87 | ◯ | ◯ | ◯ | ◯ |
| Example 8 | derivative 1 | compound 5 | | | | | | | | | |
| Inventive | Cellulose ether | Negative intrinsic birefringent | 4000 | 10 | 90 | 140 | 0.93 | ⊚ | ◯ | ◯ | ◯ |
| Example 9 | derivative 1 | compound 6 | | | | | | | | | |
| Inventive | Cellulose ether | Negative intrinsic birefringent | 800 | 20 | 89 | 140 | 0.80 | ⊚ | ◯ | ◯ | ◯ |
| Example 10 | derivative 1 | compound 7 | | | | | | | | | |
| Comparative | Cellulose ester | Negative intrinsic birefringent | 9000 | 10 | 90 | 140 | 0.87 | X | ◯ | ◯ | ◯ |
| Example 1 | derivative | compound 1 | | | | | | | | | |
| Comparative | Cellulose ether | — | — | 0 | 90 | 140 | 1.10 | ⊚ | ◯ | ◯ | X |
| Example 2 | derivative 1 | | | | | | | | | | |
| Comparative | Cellulose ether | Negative intrinsic birefringent | 794 | 9 | 75 | 140 | 0.87 | ◯ | X | X | — |
| Example 3 | derivative 1 | compound 8 | | | | | | | | | |
| Comparative | Cellulose ether | Negative intrinsic birefringent | 9000 | 15 | 50 | 140 | 0.88 | ⊚ | ◯ | X | — |
| Example 4 | derivative 1 | compound 9 | | | | | | | | | |

As presented in Table 1, the circularly retardation film according to the present invention (retardation films 1 to 10 in Inventive Examples 1 to 10) has a high transmittance at a wavelength of 320 to 400 nm, so that it can be bonded to the polarizer by means of irradiation with UV light. In addition, Table 1 shows that the circularly retardation film according to the present invention has a small retardation change, and therefore can exhibit excellent reverse wavelength dispersion characteristic even in a high-temperature and high-humidity environment. Further, the obtained circularly polarizing plates have good adhesion. Table 1 also shows that the obtained organic EL displays have excellent black color reproducibility. Differently, the retardation film 11 produced in Comparative Example 1 had a large change in retardation. The retardation film 12 produced in Comparative Example 2 did not exhibit adequate reverse wavelength dispersion characteristic in retardation, and had a bad result in terms of black color reproducibility. The retardation film 13 produced in Comparative Example 3 had a low transmittance at a wavelength of 320 to 400 nm, and significant bleed-out occurred. Moreover, due to excessively low transmittance, the retardation film 13 failed to produce any circular polarizing plate. The retardation film 14 produced in Comparative Example 4 had an excessively low transmittance at a wavelength of 320 to 400 nm, and failed to produce any circular polarizing plate.

### INDUSTRIAL APPLICABILITY

The present invention can provide a retardation film capable of exhibiting an excellent reverse wavelength dispersion characteristic while reducing a change in optical property values in a high-humidity environment, and bondable to a polarizer by using an active energy rat-curable adhesive, and an circularly polarizing plate and an image display device using the retardation film. Thus, the present invention can be suitably used, for example, in the field of image display devices requiring excellent durability and handleability in various usages or applications.

1. A retardation film comprising a cellulose ether derivative and a compound having a negative intrinsic birefringence, wherein the retardation film has:
a transmittance at a wavelength of 320 to 400 nm of 89% or more;
an in-plane retardation Ro₅₅₀ at a wavelength of 550 nm of 115 to 160 nm; and
a ratio (Ro₄₅₀/Ro₅₅₀) of an in-plane retardation Ro₄₅₀ at a wavelength of 450 nm to the Ro₅₅₀ of 0.72 to 0.94.

2. The retardation film as recited in claim 1, wherein the compound having a negative intrinsic birefringence is a polymer having a weight-average molecular weight of 800 to 20000.

3. The retardation film as recited in claim 2, wherein the polymer is one or more oligomer selected from the group consisting of an oligomer comprising a styrene derivative structure, an oligomer comprising a maleimide derivative structure, an acrylonitrile-based oligomer, and a polymethylmethacrylate-based oligomer.

4. A circularly polarizing plate comprising:
the retardation film as recited in claim 1; and
a polarizer, wherein the retardation film and the polarizer are bonded together by using an active energy ray-curative adhesive.

5. An image display device comprising the circularly polarizing plate as recited in claim 4.
